(19) United States
(12) Patent Application Publication
(10) Pub. No.: US 2011/0214895 A1
(43) Pub. Date: Sep. 8, 2011

(54) LITHIUM SECONDARY BATTERY, ELECTROLYTIC SOLUTION FOR LITHIUM SECONDARY BATTERY, ELECTRIC POWER TOOL, ELECTRICAL VEHICLE, AND ELECTRIC POWER STORAGE SYSTEM

(75) Inventors: MASAYUKI IHARA, Fukushima (JP); TADAHIKO KUBOTA, Kanagawa (JP)

(73) Assignee: SONY CORPORATION, Tokyo (JP)

(21) Appl. No.: 13/037,853

(22) Filed: Mar. 1, 2011

(30) Foreign Application Priority Data
Mar. 5, 2010 (JP) P2010-049464

(51) Int. Cl. H01M 10/056; B25F 5/00

(52) U.S. Cl. 173/217; 429/336; 429/339; 429/340; 429/325

(57) ABSTRACT

A lithium secondary battery capable of obtaining superior cycle characteristics, superior storage characteristics, and superior load characteristics is provided. The lithium secondary battery includes a cathode, an anode, and an electrolytic solution. The electrolytic solution contains a nonaqueous solvent, a lithium ion, at least one of nitrogen-containing organic anion having a Lewis acidic ligand, and at least one of inorganic anion having fluorine and an element of Group 13 to Group 15 in the long period periodic table as an element.

### CROSS REFERENCES TO RELATED APPLICATIONS

The present application claims priority Japanese Priority Patent Application JP 2010-049464 filed in the Japanese Patent Office on Mar. 5, 2010, the entire contents of which is hereby incorporated by reference.

### BACKGROUND

The present application relates to an electrolytic solution for a lithium secondary battery containing a nonaqueous solvent, a lithium secondary battery using the same, an electric power tool using the electrolytic solution for a lithium secondary battery and the lithium secondary battery, an electrical vehicle using the electrolytic solution for a lithium secondary battery and the lithium secondary battery, and an electric power storage system using the electrolytic solution for a lithium secondary battery and the lithium secondary battery.

In recent years, small electronic devices represented by a portable terminal or the like have been widely used, and it is strongly demanded to reduce their size and weight and to achieve their long life. Accordingly, as a power source for the small electronic devices, a battery, in particular, a small and light-weight secondary battery capable of providing a high energy density has been developed. In recent years, it has been considered to apply such a secondary battery not only to the foregoing small electronic devices but also to large electronic devices represented by an electrical vehicle or the like.

Specially, a lithium secondary battery using lithium reaction as charge and discharge reaction is largely prospective, since such a lithium secondary battery is able to provide a higher energy density than a lead battery and a nickel cadmium battery. The lithium secondary battery includes a lithium ion secondary battery using insertion and extraction of lithium ions and a lithium metal secondary battery using precipitation and dissolution of lithium metal.

The secondary battery includes a cathode, an anode, and an electrolytic solution. The electrolytic solution contains a nonaqueous solvent and an electrolyte salt. The electrolytic solution functioning as a medium for charge and discharge reaction largely affects performance of the secondary battery. Thus, various studies have been made on the composition of the electrolytic solution.

Specifically, to improve the cycle characteristics, safety and the like, as an electrolyte salt, a lithium salt having a Lewis acidic ligand such as lithium bis(trifluoroborane)imidazolide, lithium bis(trifluoroborane)benzimidazolide, lithium bis(trifluoroborane)dimethylamide, and lithium tris(trifluoroborane)triazole is used (for example, see Japanese Unexamined Patent Application Publication No. 2005-536832 and U.S. Patent Publication No. 2003/0108800). To improve the load characteristics, storage characteristics and the like, as a nonaqueous solvent, 1,3-dimethyl-2-imidazolizinone or 1,3-dipropyl-2-imidazolizinone is used (for example, see Japanese Unexamined Patent Application Publication Nos. 11-273728 and 2004-014248).

### SUMMARY

In these years, the high performance and the multifunctions of the electronic devices are developed, and usage frequency thereof is increased. Thus, the secondary battery tends to be frequently charged and discharged. Accordingly, further improvement of performance of the secondary battery, in particular, further improvement of the cycle characteristics, the storage characteristics, and the load characteristics of the secondary battery have been aspired.

In view of the foregoing disadvantages, in the application, it is desirable to provide an electrolytic solution for a lithium secondary battery with which superior cycle characteristics, superior storage characteristics, and superior load characteristics are able to be obtained, a lithium secondary battery, an electric power tool, an electrical vehicle, and an electric power storage system.

According to an embodiment, there is provided an electrolytic solution for a lithium secondary battery containing a nonaqueous solvent, a lithium ion (Li⁺), at least one of organic anions expressed by Formula 1 to Formula 5, and at least one of inorganic anions having fluorine and an element of Group 13 to Group 15 in the long period periodic table as an element. Further, according to an embodiment, there is provided a lithium secondary battery including a cathode, an anode, and an electrolytic solution, in which the electrolytic solution has a composition similar to that of the foregoing electrolytic solution for a lithium secondary battery of the embodiment. Further, according to an embodiment, there are provided an electric power tool, an electrical vehicle, and an electric power storage system that mounts a lithium secondary battery, in which the lithium secondary battery has a structure similar to that of the foregoing lithium secondary battery of the embodiment.

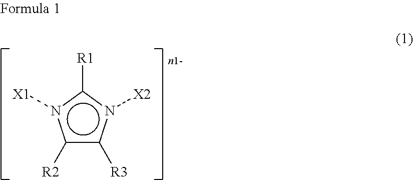

In the formula, R1 to R3 are a hydrogen group, a sulfonate ion group (—SO₃⁻), or an organic group. X1 and X2 are a Lewis acidic ligand. n1 is an integer number greater than 1 or equal to 1. R2 and R3 may be bonded to each other to form a ring structure.

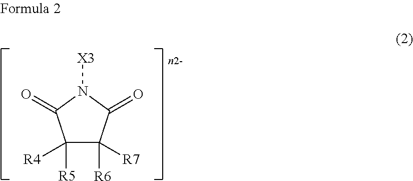

In the formula, R4 to R7 are a hydrogen group, a sulfonate ion group, or an organic group. X3 is a Lewis acidic ligand. n2 is an integer number greater than 1 or equal to 1. R4 to R7 may be bonded to each other to form a ring structure.

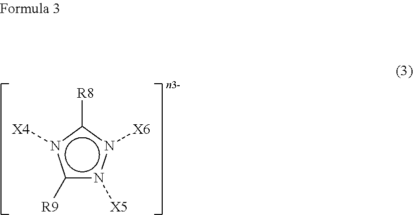

In the formula, R8 and R9 are a hydrogen group, a sulfonate ion group, or an organic group. X4 to X6 are a Lewis acidic ligand. n3 is an integer number greater than 1 or equal to 1.

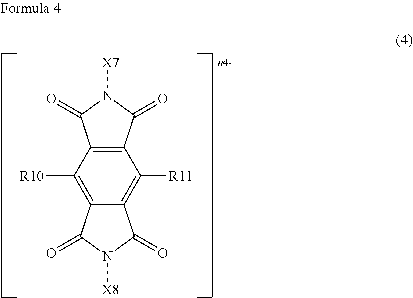

In the formula, R10 and R11 are a hydrogen group, a sulfonate ion group, or an organic group. X7 and X8 are a Lewis acidic ligand. n4 is an integer number greater than 2 or equal to 2.

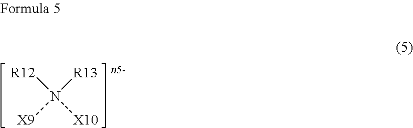

In the formula, R12 and R13 are a sulfonate ion group or an organic group. X9 and X10 are a Lewis acidic ligand. n5 is an integer number greater than 1 or equal to 1.

In the organic anion shown in Formula 2, an organic anion corresponding to the organic anion shown in Formula 4 is excluded.

The electrolytic solution for a lithium secondary battery contains the lithium ion, at least one of the organic anions, and at least one of the inorganic anions. Thereby, chemical stability is improved more than in a case that only one of the organic anion and the inorganic anion is contained. Thus, according to the lithium secondary battery using the electrolytic solution for a lithium secondary battery of the embodiment, superior cycle characteristics, superior storage characteristics and superior load characteristics are able to be obtained. Further, according to the electric power tool, the electrical vehicle, and the electric power storage system using the lithium secondary battery of the embodiment, the foregoing characteristics such as the cycle characteristics are able to be improved.

Additional features and advantages are described herein, and will be apparent from the following Detailed Description and the figures.

### BRIEF DESCRIPTION OF THE FIGURES

FIG. 1 is a cross sectional view illustrating a structure of a cylindrical type secondary battery including an electrolytic solution for a lithium secondary battery according to an embodiment.

FIG. 2 is a cross sectional view illustrating an enlarged part of a spirally wound electrode body illustrated in FIG. 1.

FIG. 3 is an exploded perspective view illustrating a structure of a laminated film type secondary battery including the electrolytic solution for a lithium secondary battery of the embodiment.

FIG. 4 is a cross sectional view taken along line IV-IV of the spirally wound electrode body illustrated in FIG. 3.

### DETAILED DESCRIPTION

Embodiments of the present application will be described below in detail with reference to the drawings.

1. Electrolytic solution for a lithium secondary battery

2. Lithium secondary battery

2-1. Lithium ion secondary battery (cylindrical type)

2-2. Lithium ion secondary battery (laminated film type)

2-3. Lithium metal secondary battery (cylindrical type and laminated film type)

3. Application of the lithium secondary battery

### 1. Electrolytic Solution for a Lithium Secondary Battery

An electrolytic solution for a lithium secondary battery according to an embodiment (hereinafter simply referred to as “electrolytic solution”) contains a nonaqueous solvent and an electrolyte salt. The electrolyte salt contains, as a component ion, a lithium ion (lithium cation), one or more of organic anions expressed by Formula 1 to Formula 5, and one or more of inorganic anions having fluorine and an element of Group 13 to Group 15 in the long period periodic table as an element. The foregoing organic anion will be hereinafter referred to as “nitrogen-containing organic anion”, and the foregoing inorganic anion will be hereinafter referred to as “fluorine-containing inorganic anion.” The electrolytic solution contains the nitrogen-containing organic anion and the fluorine-containing inorganic anion together, since the chemical stability is thereby improved more than in a case that the electrolytic solution contains only one thereof

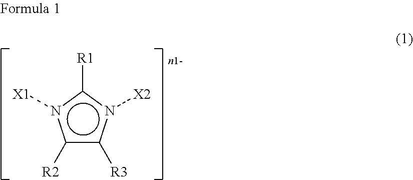

In the formula, R1 to R3 are a hydrogen group, a sulfonate ion group (—SO₃⁻), or an organic group. X1 and X2 are a Lewis acidic ligand. n1 is an integer number greater than 1 or equal to 1. R2 and R3 may be bonded to each other to form a ring structure.

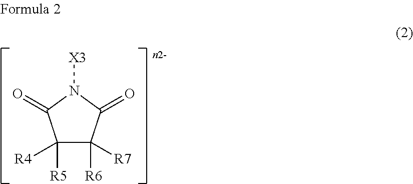

In the formula, R4 to R7 are a hydrogen group, a sulfonate ion group, or an organic group. X3 is a Lewis acidic ligand. n2 is an integer number greater than or equal to 1. R4 to R7 may be bonded to each other to form a ring structure.

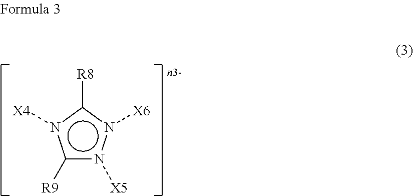

In the formula, R8 and R9 are a hydrogen group, a sulfonate ion group, or an organic group. X4 to X6 are a Lewis acidic ligand. n3 is an integer number greater than 1 or equal to 1.

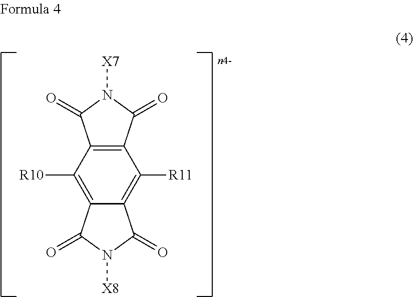

In the formula, R10 and R11 are a hydrogen group, a sulfonate ion group, or an organic group. X7 and X8 are a Lewis acidic ligand. n4 is an integer number greater than 2 or equal to 2.

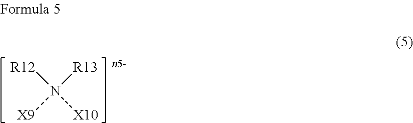

In the formula, R12 and R13 are a sulfonate ion group or an organic group. X9 and X10 are a Lewis acidic ligand. n5 is an integer number greater than 1 or equal to 1.

Lithium Ion, Nitrogen-Containing Organic Anion, and Fluorine-Containing Inorganic Anion

Lithium ions are generated by ionization of the electrolyte salt (lithium salt) of the electrolytic solution in the nonaqueous solvent. The lithium ions function as, for example, an electrode reactant (carrier) in the lithium secondary battery. The lithium ions may be generated by ionization of a salt containing the nitrogen-containing organic anion, may be generated by ionization of a salt containing the fluorine-containing inorganic anion, or may be generated by ionization of other electrolyte salt. Specially, the lithium ions are preferably generated from a state that the electrolytic solution contains a lithium salt containing the nitrogen-containing organic anion and a lithium salt containing the fluorine-containing inorganic anion, since thereby chemical stability of the electrolytic solution is sufficiently improved.

The nitrogen-containing organic anion shown in Formula 1 is an imidazole anion having an imidazole skeleton and a Lewis acid that is coordination-bonded to a nitrogen atom (hetero atom) contained in the imidazole skeleton. R1 to R3 may be the same type of group, or may be a group different from each other. X1 and X2 may be the same ligand, or may be a ligand different from each other.

A description will be hereinafter given of details of R1 to R3. Examples of the organic group include a carbon hydride group such as an alkyl group, an alkenyl group, an alkynyl group, and an aryl group or a halogenated group thereof. Examples of the organic group also include an alkoxy group or a halogenated group thereof, a group having a heterocycle, a group having a carbonyl group, a group having ether bond, a group having amide bond, and a group having sulfonic ester bond. Further, examples of the organic group include a carboxylic group, a carboxylate ion group, a cyano group, and an isocyanate group. In addition to the foregoing groups, the organic group may be a derivative thereof, but is not limited thereto. The derivative means, for example, a group obtained by introducing one or more substituted groups to, for example, the alkyl group or the like. Such a substituted group may be a carbon hydride group, or may be a group other than the carbon hydride group such as a halogen group, a nitro group, a sulfonate group, a sulfonate ion group, and an amine group.

A description will be hereinafter given of details of the carbon hydride group. Examples of the alkyl group include a methyl group, an ethyl group, an n (normal)-propyl group, an isopropyl group, an n-butyl group, and an isobutyl group. Examples of the alkyl group also include a sec (secondary)-butyl group, a tert (tertiary)-butyl group, an n-pentyl group, a 2-methylbutyl group, 3-methylbutyl group, 2,2-dimethylpropyl group, and an n-hexyl group. Examples of the alkenyl group include an n-heptyl group, a vinyl group, a 2-methylvinyl group, a 2,2-dimethylvinyl group, a butene-2,4-diyl group, and an aryl group. Examples of the alkynyl group include an ethynyl group. Examples of the aryl group include a phenyl group, a benzil group, a 2-phenylethyl group (phenethyl group), a tolyl group, a xylyl group, a naphtyl group, a phenanthrene group, and an anthracene group.

For the halogenated carbon hydride group and the halogenated alkoxy group, though the type of halogen is not particularly limited, specially, fluorine (F), chlorine (Cl), or bromine (Br) is preferable, and fluorine is more preferable. Among the halogenated carbon hydride group, examples of halogenated alkyl groups include a fluorinated alkyl group. Examples of the fluorinated alkyl group include a fluoromethyl group, a difluoromethyl group, a trifluoromethyl group, a 2,2,2-trifluoroethyl group, a pentafluoroethyl group, and a 1,1,1,3,3,3-hexafluoropropyl group. “Halogenated group” means a group obtained by substituting at least partial hydrogen group (—H) out of the alkyl group or the like with a halogen group (—F or the like).

Specially, the organic group is preferably the carbon hydride group or the halogenated carbon hydride group, since such a group is able to be easily synthesized, and is able to provide high chemical stability in the electrolytic solution. Though the carbon number of the carbon hydride group or the halogenated carbon hydride group is not particularly limited, the carbon number thereof is preferably from 1 to 10 both inclusive, is more preferably from 1 to 7 both inclusive, and is most preferably from 1 to 3 both inclusive for the following reason. That is, in this case, bulk of the nitrogen-containing organic anion is easily decreased. Thereby, viscosity of the electrolytic solution is kept low, and thus higher ion mobility is able to be obtained in the electrolytic solution.

However, R2 and R3 may be bonded to each other to form a ring structure. The ring structure may be, for example, an aromatic ring, a heterocycle, or an alicyclic structure, and is not particularly limited. Examples of the ring structure include a benzene ring, a benzoimidazole ring, and a structure in which a benzene ring and a pyrrole-2,5-dione ring are condensed.

A description will be hereinafter given of details of X1 and X2. The Lewis acidic ligand is a Lewis acid that is coordination-bonded to a nitrogen atom having an unshared electron pair contained in a heterocyclic skeleton. Examples of the Lewis acid include BF₃, B(OCH₃)₃, B(C₆H₅)₃, B(C₆F₅)₃, and B(OCH(CF₃)₂)₃. Though the Lewis acidic ligand is not limited to the foregoing examples, specially, the Lewis acidic ligand is preferably BF₃ or B(C₆F₅)₃, since BF₃ or B(C₆F₅)₃ is able to be easily synthesized, and is able to provide high chemical stability in the electrolytic solution.

n1 represents anion valency in Formula 1, and is a given integer number greater than 1 or equal to 1. In the case where R1 to R3 have an anion group such as a sulfonate ion group and a carboxylic ion group, n1 is a number greater than 2 or equal to 2.

Specific examples of the nitrogen-containing organic anion shown in Formula 1 include anions expressed by Formula (1-1) to Formula (1-17), since thereby in the electrolytic solution, sufficient ion mobility is able to be obtained and chemical stability is sufficiently improved. However, the nitrogen-containing organic anion shown in Formula 1 may be a nitrogen-containing organic anion other than the anions show in Formula (1-1) to Formula (1-17).

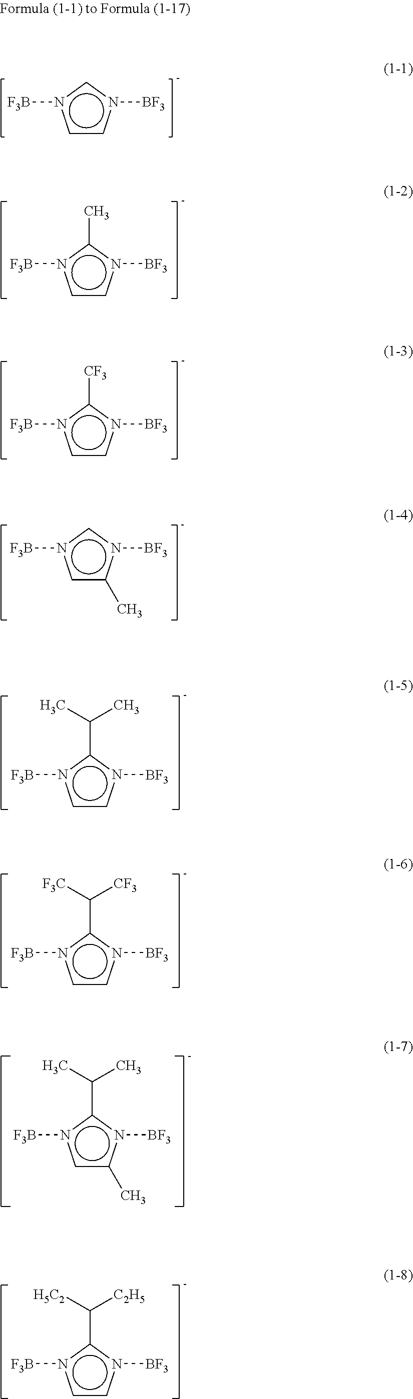

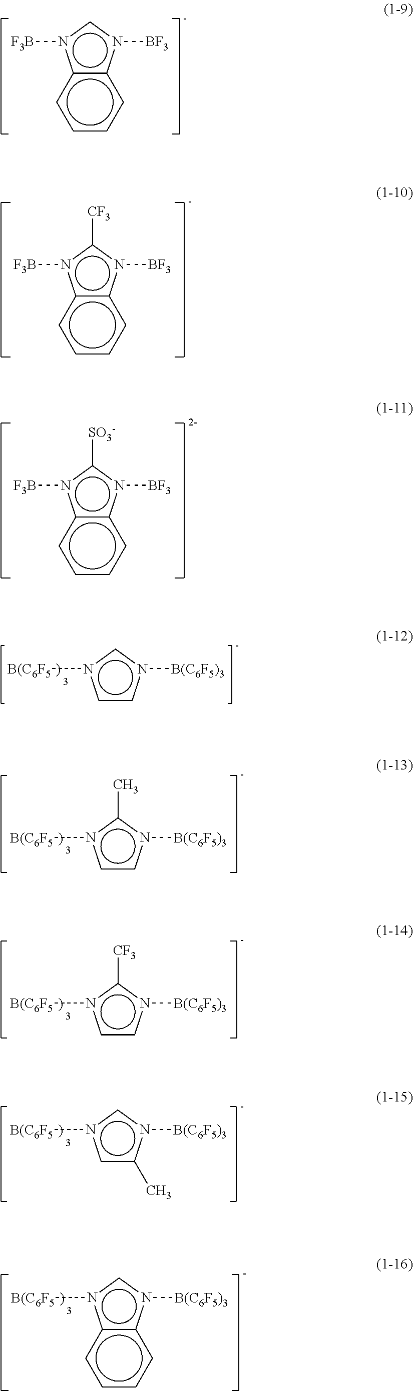

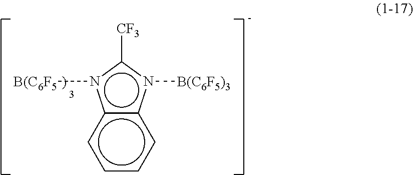

The nitrogen-containing organic anion shown in Formula 1 is used in a state that a cation and a salt are formed in the electrolytic solution. Thus, the nitrogen-containing organic anion shown in Formula 1 may be contained in the electrolytic solution as a salt thereof. In this case, the cation type is not particularly limited and, for example, is a light metal ion such as a lithium ion, a sodium ion, a potassium ion, a magnesium ion, a calcium ion, and an aluminum ion; an organic cation or the like. Specially, the nitrogen-containing organic anion shown in Formula 1 is preferably used as a lithium salt for the electrolytic solution, since thereby chemical stability of the electrolytic solution is sufficiently improved.

Examples of the lithium salt of the nitrogen-containing organic anion shown in Formula 1 include lithium salts expressed by Formula (1-21) to Formula (1-23), since thereby such lithium salts are ionized in the electrolytic solution and accordingly sufficient ion mobility is able to be obtained and chemical stability is sufficiently improved. However, a salt containing the nitrogen-containing organic anion shown in Formula 1 may be a lithium salt other than the lithium salts expressed by Formula (1-21) to Formula (1-23), or other salt.

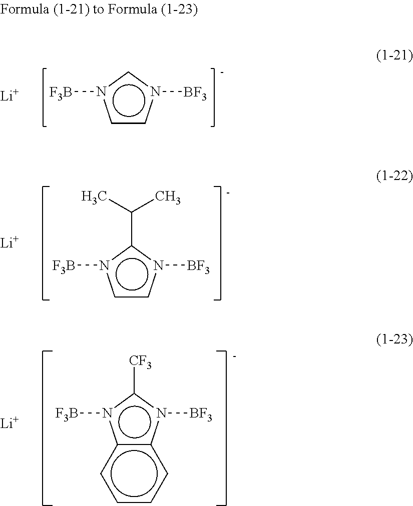

The nitrogen-containing organic anion shown in Formula 2 is a pyrrolidinedione anion having a 2,5-pyrrolidinedione skeleton and a Lewis acid that is coordination-bonded to a nitrogen atom contained in the 2,5-pyrrolidinedione skeleton. In the nitrogen-containing organic anion shown in Formula 2, a nitrogen-containing organic anion corresponding to the nitrogen-containing organic anion shown in Formula 4 described later is excluded. R4 to R7 may be the same type of group, or may be a group different from each other. Details of R4 to R7 are similar to the foregoing details of R1 to R3. Details of X3 are similar to the foregoing details of X1 and X2. Details of n2 are similar to the foregoing details of n1. R4 to R7 may be bonded to each other to form a ring structure. The ring structure may be, for example, an aromatic ring, a heterocycle, or an alicyclic structure, and is not particularly limited. Examples of the ring structure include a benzene ring, and a benzoimidazole ring.

Specific examples of the nitrogen-containing organic anion shown in Formula 2 include an anion expressed by Formula (2-1) or Formula (2-2), since thereby in the electrolytic solution, sufficient ion mobility is able to be obtained and chemical stability is sufficiently improved. However, the nitrogen-containing organic anion shown in Formula 2 may be a nitrogen-containing organic anion other than the anion shown in Formula (2-1) or Formula (2-2).

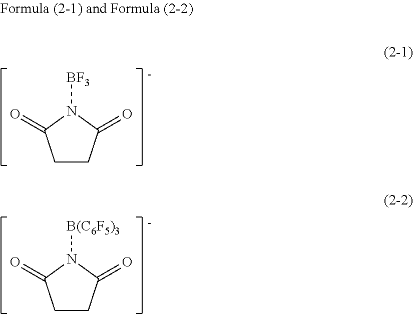

The nitrogen-containing organic anion shown in Formula 2 is also used in a state that a cation and a salt are formed in the electrolytic solution as the nitrogen-containing organic anion shown in Formula 1 is. Thus, the nitrogen-containing organic anion shown in Formula 2 may be contained in the electrolytic solution as a salt. In this case, the cation is a cation similar to the cation capable of forming a salt with the nitrogen-containing organic anion shown in Formula 1. Specially, the nitrogen-containing organic anion shown in Formula 2 is also preferably used as a lithium salt for the electrolytic solution, since thereby chemical stability of the electrolytic solution is sufficiently improved.

Examples of the lithium salt of the nitrogen-containing organic anion shown in Formula 2 include a lithium salt expressed by Formula (2-11) or Formula (2-12), since thereby such a lithium salt is ionized in the electrolytic solution and accordingly sufficient ion mobility is able to be obtained and chemical stability is sufficiently improved. However, a salt containing the nitrogen-containing organic anion shown in Formula 2 may be a lithium salt other than the lithium salt shown in Formula (2-11) or Formula (2-12), or other salt.

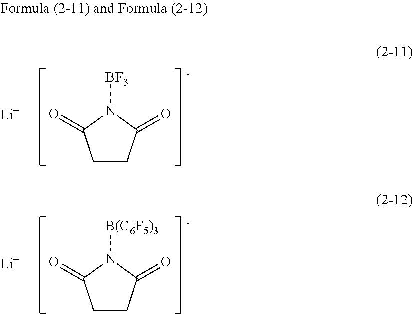

The nitrogen-containing organic anion shown in Formula 3 is a triazole anion having a triazole skeleton and a Lewis acid that is coordination-bonded to a nitrogen atom contained in the triazole skeleton. R8 and R9 may be the same type of group, or may be a group different from each other. X4 to X6 may be the same type of ligand, or may be a ligand different from each other. Details of R8 and R9 are similar to the foregoing details of R2 and R3. Details of X4 to X6 are similar to the foregoing details of X1 and X2. Details of n3 are similar to the foregoing details of n1.

Specific examples of the nitrogen-containing organic anion shown in Formula 3 include an anion expressed by Formula (3-1) or Formula (3-2), since thereby in the electrolytic solution, sufficient ion mobility is able to be obtained and chemical stability is sufficiently improved. However, the nitrogen-containing organic anion shown in Formula 3 may be a nitrogen-containing organic anion other than the anion shown in Formula (3-1) or Formula (3-2).

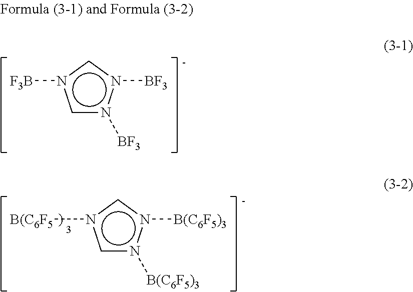

The nitrogen-containing organic anion shown in Formula 3 is also used in a state that a cation and a salt are formed in the electrolytic solution as the nitrogen-containing organic anion shown in Formula 1 is. Thus, the nitrogen-containing organic anion shown in Formula 3 may be contained in the electrolytic solution as a salt. In this case, the cation is a cation similar to the cation capable of forming a salt with the nitrogen-containing organic anion shown in Formula 1. Specially, the nitrogen-containing organic anion shown in Formula 3 is also preferably used as a lithium salt for the electrolytic solution, since thereby chemical stability of the electrolytic solution is sufficiently improved.

Examples of the lithium salt of the nitrogen-containing organic anion shown in Formula 3 include a lithium salt expressed by Formula (3-11) or Formula (3-12), since thereby such a lithium salt is ionized in the electrolytic solution and accordingly sufficient ion mobility is able to be obtained and chemical stability is sufficiently improved. However, a salt containing the nitrogen-containing organic anion shown in Formula 3 may be a lithium salt other than the lithium salt shown in Formula (3-11) or Formula (3-12), or other salt.

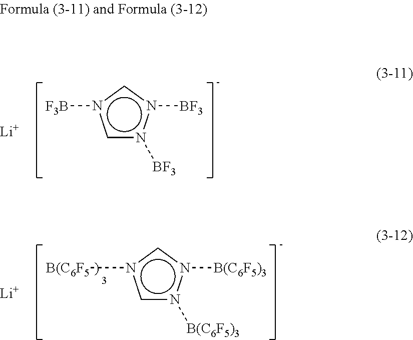

The nitrogen-containing organic anion shown in Formula 4 is a pyrrole-2,5-dione anion having a skeleton in which pyrrole-2,5-dione and a benzene ring are condensed and a Lewis acid that is coordination-bonded to a nitrogen atom contained in the skeleton part of pyrrole-2,5-dione. R10 and R11 may be the same type of group, or may be a group different from each other. X7 and X8 may be the same type of ligand, or may be a ligand different from each other. Details of R10 and R11 are similar to the foregoing details of R2 and R3. Details of X7 and X8 are similar to the foregoing details of X1 and X2. Further, n4 represents anion valency in Formula 4. n4 is a given integer number greater than 2 or equal to 2. In the case where R10 or R11 has an anion group such as a sulfonate ion group and a carboxylic ion group, n4 is a number greater than 3 or equal to 3.

Specific examples of the nitrogen-containing organic anion shown in Formula 4 include an anion expressed by Formula (4-1) or Formula (4-2), since thereby in the electrolytic solution, sufficient ion mobility is able to be obtained and chemical stability is sufficiently improved. However, the nitrogen-containing organic anion shown in Formula 4 may be a nitrogen-containing organic anion other than the anion shown in Formula (4-1) or Formula (4-2).

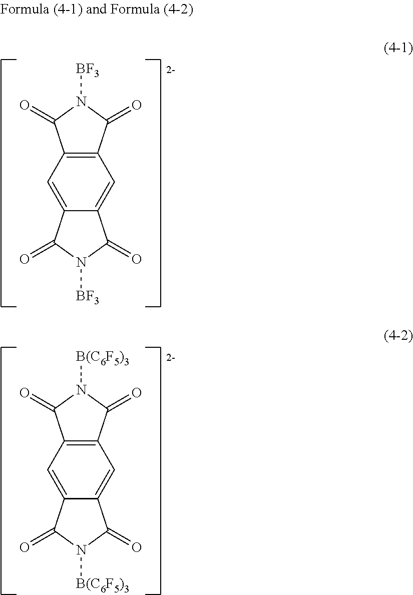

The nitrogen-containing organic anion shown in Formula 4 is also used in a state that a cation and a salt are formed in the electrolytic solution as the nitrogen-containing organic anion shown in Formula 1 is. Thus, the nitrogen-containing organic anion shown in Formula 4 may be contained in the electrolytic solution as a salt. In this case, the cation is a cation similar to the cation capable of forming a salt with the nitrogen-containing organic anion shown in Formula 1. Specially, the nitrogen-containing organic anion shown in Formula 4 is also preferably used as a lithium salt for the electrolytic solution, since thereby chemical stability of the electrolytic solution is sufficiently improved.

Examples of the lithium salt of the nitrogen-containing organic anion shown in Formula 4 include a lithium salt expressed by Formula (4-11) or Formula (4-12), since thereby such a lithium salt is ionized in the electrolytic solution and accordingly sufficient ion mobility is able to be obtained and chemical stability is sufficiently improved. However, a salt containing the nitrogen-containing organic anion shown in Formula 4 may be a lithium salt other than the lithium salt shown in Formula (4-11) or Formula (4-12), or other salt.

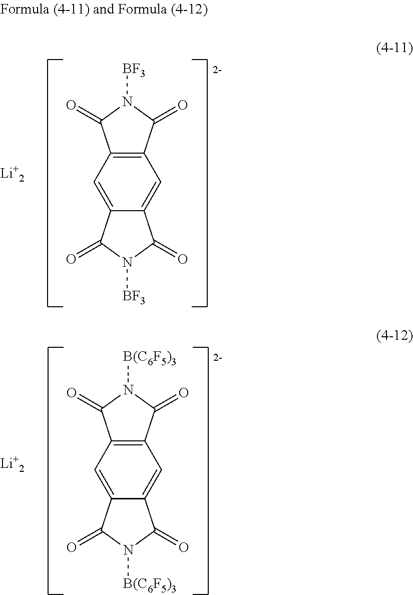

The nitrogen-containing organic anion shown in Formula 5 is an amide anion having a Lewis acid that is coordination-bonded to a nitrogen atom contained in amide. R12 and R13 may be the same type of group, or may be a group different from each other. X9 and X10 may be the same ligand, or may be a ligand different from each other. Details of R12 and R13 are similar to the foregoing details of R2 and R3 except that R12 and R13 are a hydrogen group. Details of X9 and X10 are similar to the foregoing details of X1 and X2. Details of n5 are similar to the foregoing details of n1.

Specific examples of the nitrogen-containing organic anion shown in Formula 5 include anions expressed by Formula (5-1) to Formula (5-6), since thereby in the electrolytic solution, sufficient ion mobility is able to be obtained and chemical stability is sufficiently improved. However, the nitrogen-containing organic anion shown in Formula 5 may be a nitrogen-containing organic anion other than the anions expressed by Formula (5-1) to Formula (5-6).

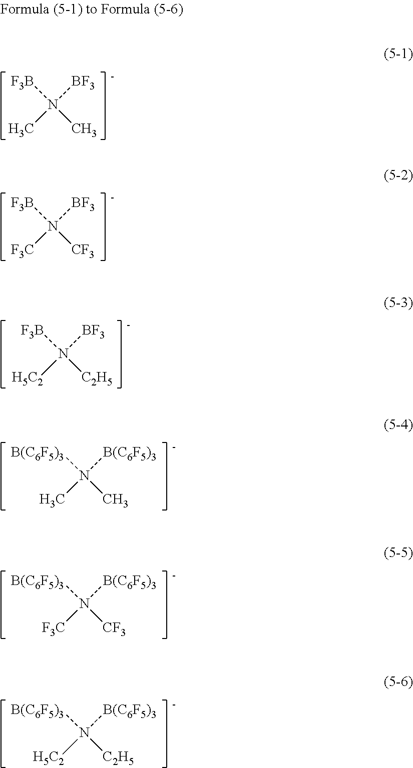

The nitrogen-containing organic anion shown in Formula 5 is also used in a state that a cation and a salt are formed in the electrolytic solution as the nitrogen-containing organic anion shown in Formula 1 is. Thus, the nitrogen-containing organic anion shown in Formula 5 may be contained in the electrolytic solution as a salt. In this case, the cation is a cation similar to the cation capable of forming a salt with the nitrogen-containing organic anion shown in Formula 1. Specially, the nitrogen-containing organic anion shown in Formula 5 is also preferably used as a lithium salt for the electrolytic solution, since thereby chemical stability of the electrolytic solution is sufficiently improved.

Examples of the lithium salt of the nitrogen-containing organic anion shown in Formula 5 include a lithium salt expressed by Formula (5-11) or Formula (5-12), since thereby such a lithium salt is ionized in the electrolytic solution and accordingly sufficient ion mobility is able to be obtained and chemical stability is sufficiently improved. However, a salt containing the nitrogen-containing organic anion shown in Formula 5 may be a lithium salt other than the lithium salt shown in Formula (5-11) or Formula (5-12), or other salt.

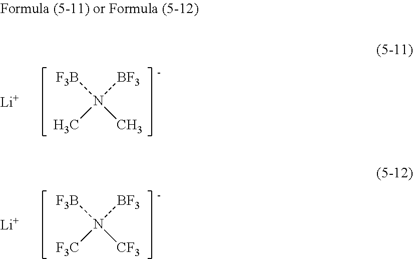

The fluorine-containing inorganic anion is not particularly limited, as long as the fluorine-containing inorganic anion contains fluorine and an element of Group 13 to Group 15 in the long period periodic table as an element and does not contain carbon. Examples of the fluorine-containing inorganic anion include the following inorganic anions: hexafluorophosphate ion (PF₆⁻), tetrafluoroborate ion (BF₄⁻), hexafluoroarsenate ion (AsF₆⁻), hexafluorosilicate ion (SiF₆²⁻), monofluorophosphate ion (PF₂O₂⁻), and difluorophosphate ion (PF₂O₂⁻). By using such a fluorine-containing inorganic anion, chemical stability of the electrolytic solution is sufficiently improved. Specially, hexafluorophosphate ion (PF₆⁻) or tetrafluoroborate ion (BF₄⁻) is preferable, since thereby chemical stability of the electrolytic solution is further improved.

The fluorine-containing inorganic anion is also used in a state that a cation and a salt are formed in the electrolytic solution as the nitrogen-containing organic anion is. Thus, the fluorine-containing inorganic anion may be contained in the electrolytic solution as a salt. In this case, the cation is a cation similar to the cation capable of forming a salt with the nitrogen-containing organic anion shown in Formula 1. Specially, the fluorine-containing inorganic anion is also preferably used as a lithium salt for the electrolytic solution, since thereby chemical stability of the electrolytic solution is sufficiently improved.

Examples of the lithium salt of the fluorine-containing inorganic anion include lithium hexafluorophosphate (LiPF₆), lithium tetrafluoroborate (LiBF₄), lithium hexafluoroarsenate (LiAsF₆), dilithium hexafluorosilicate (Li₂SiF₆), dilithium monofluorophosphate (Li₂ PFO₃), and lithium difluorophosphate (LiPF₂O₂). Such a lithium salt is ionized in the electrolytic solution and accordingly sufficient ion mobility is able to be obtained and chemical stability is sufficiently improved. However, a salt containing the fluorine-containing inorganic anion may be a lithium salt other than the foregoing lithium salts, or other salt.

Though the content of the lithium ion is not particularly limited, the content of the lithium ion is preferably from 0.3 mol/kg to 3.0 mol/kg both inclusive with respect to the nonaqueous solvent, since thereby high ion conductivity is able to be obtained.

Though the content of the nitrogen-containing organic anion and the content of the fluorine-containing inorganic anion are not particularly limited, the content of the fluorine-containing inorganic anion is preferably higher than the content of the nitrogen-containing organic anion, since thereby chemical stability of the electrolytic solution is sufficiently improved. Specially, the content of the nitrogen-containing organic anion is preferably from 0.001 mol/kg to 0.5 mol/kg both inclusive with respect to the nonaqueous solvent, and is more preferably from 0.1 mol/kg to 0.3 mol/kg both inclusive with respect to the nonaqueous solvent, since thereby in the electrolytic solution, sufficient ion mobility is able to be obtained and chemical stability is more improved. Further, the content of the fluorine-containing inorganic anion is preferably from 0.3 mol/kg to 2.5 mol/kg both inclusive with respect to the nonaqueous solvent, and is more preferably from 0.7 mol/kg to 1.2 mol/kg both inclusive with respect to the nonaqueous solvent, since thereby in the electrolytic solution, sufficient ion mobility is able to be obtained and chemical stability is more improved.

In particular, the nitrogen-containing organic anion is preferably contained in the electrolytic solution at a ratio from 0.001 mol to 0.5 mol both inclusive per 1 mol of the fluorine-containing inorganic anion, and is more preferably contained in the electrolytic solution at a ratio from 0.1 mol to 0.3 mol both inclusive per 1 mol of the fluorine-containing inorganic anion. That is, the molar ratio of the nitrogen-containing organic anion with respect to the fluorine-containing inorganic anion (the number of moles of the nitrogen-containing organic anion/the number of moles of the fluorine-containing inorganic anion) is preferably from 0.001 to 0.5 both inclusive, and is more preferably from 0.1 to 0.3 both inclusive, since thereby chemical stability of the electrolytic solution is more improved.

Nonaqueous Solvent

The nonaqueous solvent contains one or more of the organic solvents described below.

Examples of the nonaqueous solvents include the following. That is, examples thereof include ethylene carbonate, propylene carbonate, butylene carbonate, dimethyl carbonate, diethyl carbonate, ethyl methyl carbonate, methylpropyl carbonate, y-butyrolactone, y-valerolactone, 1,2-dimethoxyethane, and tetrahydrofuran. Further examples thereof include 2-methyltetrahydrofuran, tetrahydropyran, 1,3-dioxolane, 4-methyl-1,3-dioxolane, 1,3-dioxane, and 1,4-dioxane. Furthermore, examples thereof include methyl acetate, ethyl acetate, methyl propionate, ethyl propionate, methyl butyrate, methyl isobutyrate, trimethyl methyl acetate, and trimethyl ethyl acetate. Furthermore, examples thereof include acetonitrile, glutaronitrile, adiponitrile, methoxyacetonitrile, 3-methoxypropionitrile, N,N-dimethylformamide, N-methylpyrrolidinone, and N-methyloxazolidinone. Furthermore, examples thereof include N,N′-dimethylimidazolidinone, nitromethane, nitroethane, sulfolane, trimethyl phosphate, and dimethyl sulfoxide. By using such a compound, superior battery capacity, superior cycle characteristics, superior storage characteristics and the like are obtained in the lithium secondary battery using the electrolytic solution.

Specially, one or more of ethylene carbonate, propylene carbonate, dimethyl carbonate, diethyl carbonate, and ethyl methyl carbonate is preferable, since thereby superior battery capacity, superior cycle characteristics, superior storage characteristics and the like are obtained. In this case, a combination of a high viscosity (high dielectric constant) solvent (for example, specific inductive ∈≧30) such as ethylene carbonate and propylene carbonate and a low viscosity solvent (for example, viscosity≦1 mPa·s) such as dimethyl carbonate, ethylmethyl carbonate, and diethyl carbonate is more preferable. Thereby, dissociation property of the electrolyte salt and ion mobility are improved.

In particular, the nonaqueous solvent preferably contains one or more of the unsaturated carbon bond cyclic ester carbonates expressed by Formula 6 to Formula 8. Thereby, a stable protective film is formed on the surface of the electrode at the time of charge and discharge of the lithium secondary battery, and thus decomposition reaction of the electrolytic solution is inhibited. The “unsaturated carbon bond cyclic ester carbonate” is a cyclic ester carbonate having one or more unsaturated carbon bond. R21 and R22 may be the same type of group, or may be a group different from each other. The same is applied to R23 to R26. The content of the unsaturated carbon bond cyclic ester carbonate in the nonaqueous solvent is, for example, from 0.01 wt % to 10 wt % both inclusive. However, the unsaturated carbon bond cyclic ester carbonate is not limited to the after-mentioned examples and may be other compound.

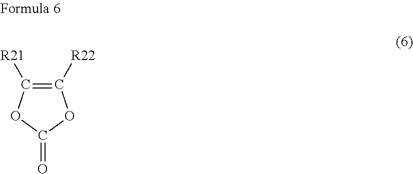

In the formula, R21 and R22 are a hydrogen group or an alkyl group.

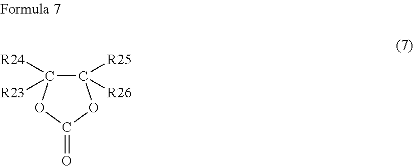

In the formula, R23 to R26 are a hydrogen group, an alkyl group, a vinyl group, or an aryl group. At least one of R23 to R26 is the vinyl group or the aryl group.

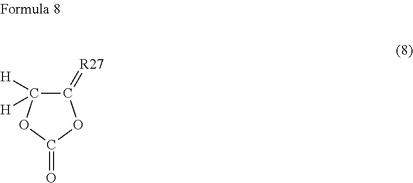

In the formula, R27 is an alkylene group.

The unsaturated carbon bond cyclic ester carbonate shown in Formula 6 is a vinylene carbonate compound. Examples of vinylene carbonate compounds include the following compounds. That is, examples thereof include vinylene carbonate, methylvinylene carbonate, and ethylvinylene carbonate. Further, examples thereof include 4,5-dimethyl-1,3-dioxole-2-one, 4,5-diethyl-1,3-dioxole-2-one, 4-fluoro-1,3-dioxole-2-one, and 4-trifluoromethyl-1,3-dioxole-2-one. Specially, vinylene carbonate is preferable, since vinylene carbonate is easily available and provides high effect.

The unsaturated carbon bond cyclic ester carbonate shown in Formula 7 is a vinylethylene carbonate compound. Examples of the vinylethylene carbonate compounds include the following compounds. That is, examples thereof include vinylethylene carbonate, 4-methyl-4-vinyl-1,3-dioxolane-2-one, and 4-ethyl-4-vinyl-1,3-dioxolane-2-one. Further examples thereof include 4-n-propyl-4-vinyl-1,3-dioxolane-2-one, 5-methyl-4-vinyl-1,3-dioxolane-2-one, 4,4-divinyl-1,3-dioxolane-2-one, and 4,5-divinyl-1,3-dioxolane-2-one. Specially, vinylethylene carbonate is preferable, since vinylethylene carbonate is easily available, and provides high effect. It is needless to say that all of R23 to R26 may be the vinyl group or the aryl group. Otherwise, it is possible that some of R23 to R26 are the vinyl group, and the others thereof are the aryl group.

The unsaturated carbon bond cyclic ester carbonate shown in Formula 8 is a methylene ethylene carbonate compound. Examples of the methylene ethylene carbonate compounds include the following compounds. That is, examples thereof include 4-methylene-1,3-dioxolane-2-one, 4,4-dimethyl-5-methylene-1,3-dioxolane-2-one, and 4,4-diethyl-5-methylene-1,3-dioxolane-2-one. The methylene ethylene carbonate compound may have one methylene group (for example, the compound shown in Formula 8), or may have two methylene groups.

The unsaturated carbon bond cyclic ester carbonate may be catechol carbonate having a benzene ring or the like, in addition to the compounds shown in Formula 6 to Formula 8.

Further, the nonaqueous solvent preferably contains one or more of halogenated chain ester carbonates expressed by Formula 9 and halogenated cyclic ester carbonates expressed by Formula 10. Thereby, a stable protective film is formed on the surface of the electrode at the time of charge and discharge of the secondary battery, and thus decomposition reaction of the electrolytic solution is inhibited. “Halogenated chain ester carbonate” is a chain ester carbonate having halogen as an element. Further, “halogenated cyclic ester carbonate” is a cyclic ester carbonate having halogen as an element. R31 to R36 may be the same type of group, or may be a group different from each other. The same is applied to R37 to R40. The content of the halogenated chain ester carbonate and the content of the halogenated cyclic ester carbonate in the nonaqueous solvent are, for example, from 0.01 wt % to 50 wt % both inclusive. However, the halogenated chain ester carbonate or the halogenated cyclic ester carbonate is not necessarily limited to the compounds described below but may be other compound.

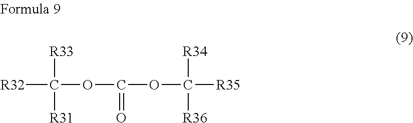

In the formula, R31 to R36 are a hydrogen group, a halogen group, an alkyl group, or a halogenated alkyl group. At least one of R31 to R36 is the halogen group or the halogenated alkyl group.

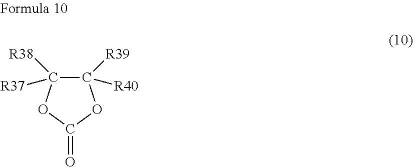

In the formula, R37 to R40 are a hydrogen group, a halogen group, an alkyl group, or a halogenated alkyl group. At least one of R37 to R40 is the halogen group or the halogenated alkyl group.

The halogen type is not particularly limited, but specially, fluorine, chlorine, or bromine is preferable, and fluorine is more preferable since thereby higher effect is obtained compared to other halogen. The number of halogen is more preferably two than one, and further may be three or more, since thereby an ability to form a protective film is improved, and a more rigid and stable protective film is formed. Accordingly, decomposition reaction of the electrolytic solution is more inhibited.

Examples of the halogenated chain ester carbonate include fluoromethyl methyl carbonate, bis(fluoromethyl) carbonate, and difluoromethyl methyl carbonate. Examples of the halogenated cyclic ester carbonate include the compounds shown in Formula (10-1) to Formula (10-21). The halogenated cyclic ester carbonate include a geometric isomer. Specially, 4-fluoro-1,3-dioxolane-2-one shown in Formula (10-1) or 4,5-difluoro-1,3-dioxolane-2-one shown in Formula (10-3) is preferable, and the latter is more preferable. In particular, as 4,5-difluoro-1,3-dioxolane-2-one, a trans isomer is more preferable than a cis isomer, since the trans isomer is easily available and provides high effect.

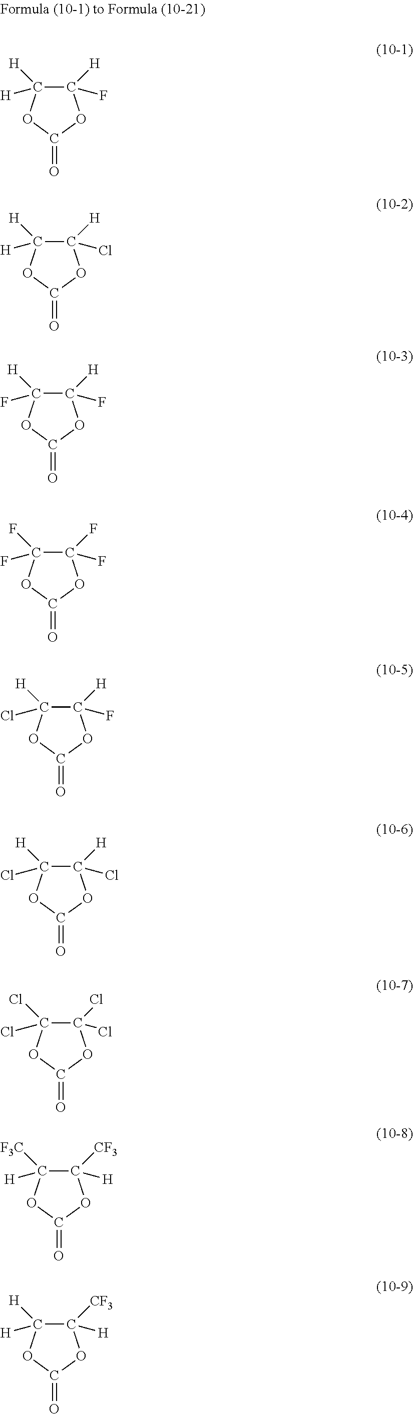

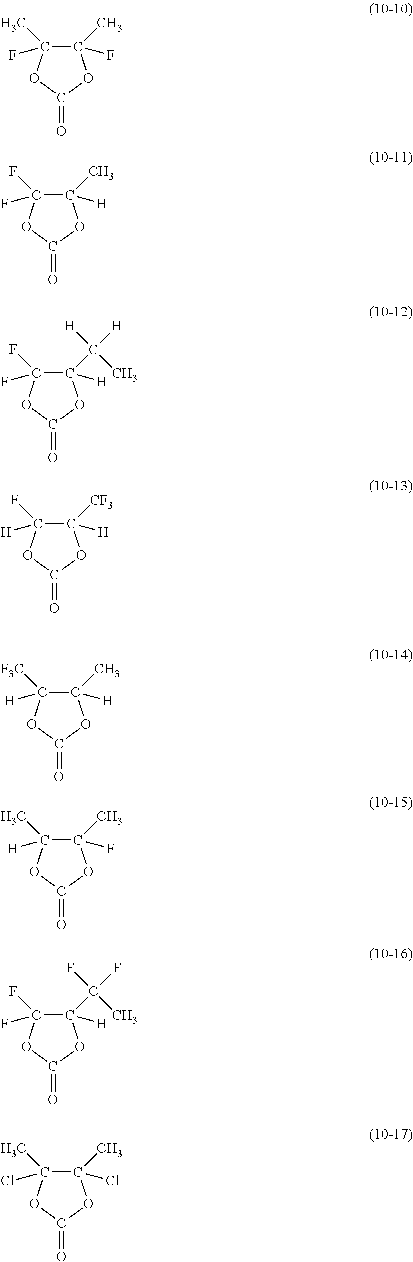

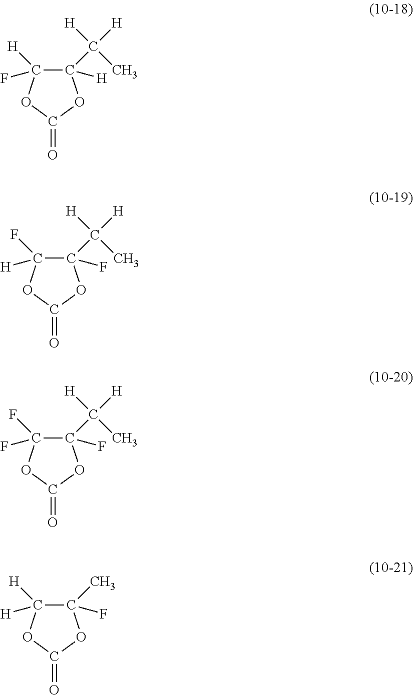

Further, the nonaqueous solvent preferably contains sultone (cyclic sulfonic ester), since thereby the chemical stability of the electrolytic solution is more improved. Examples of the sultone include propane sultone and propene sultone. The sultone content in the nonaqueous solvent is, for example, from 0.5 wt % to 5 wt % both inclusive. Sultone is not limited to the foregoing compound, but may be other compound.

Further, the nonaqueous solvent preferably contains an acid anhydride since the chemical stability of the electrolytic solution is thereby further improved. Examples of the acid anhydrides include a carboxylic anhydride, a disulfonic anhydride, and an anhydride of carboxylic acid and sulfonic acid. Examples of the carboxylic anhydrides include succinic anhydride, glutaric anhydride, and maleic anhydride. Examples of disulfonic anhydrides include ethane disulfonic anhydride and propane disulfonic anhydride. Examples of the anhydride of carboxylic acid and sulfonic acid include sulfobenzoic anhydride, sulfopropionic anhydride, and sulfobutyric anhydride. The content of the acid anhydride in the nonaqueous solvent is from 0.5 wt % to 5 wt % both inclusive. However, acid anhydride is not limited to the foregoing compound, and may be other compound.

Other Electrolyte Salt

The electrolyte salt may contain, for example, one or more of lithium salts described below and salts other than the lithium salt (for example, a light metal salt other than the lithium salt) in addition to the foregoing lithium salt to become lithium ions, the foregoing salt containing the nitrogen-containing organic anion, and the foregoing salt containing the fluorine-containing inorganic anion. For the foregoing salt containing the organic anions shown in Formula 1 to Formula 5 and the foregoing salt containing the fluorine-containing inorganic anion, the description will be omitted.

Examples of lithium salts include the following. That is, examples thereof include lithium perchlorate (LiClO₄), lithium tetraphenylborate (LiB(C₆H₅)₄), lithium methanesulfonate (LiCH₃SO₃), lithium trifluoromethane sulfonate (LiCF₃SO₃), lithium tetrachloroaluminate (LiAlCl₄), lithium chloride (LiCl), and lithium bromide (LiBr). Thereby, superior battery capacity, superior cycle characteristics, superior storage characteristics and the like are obtained in the lithium secondary battery. However, the lithium salt is not limited to the foregoing compound, and may be other compound.

In particular, the electrolyte salt preferably contains one or more of compounds expressed by Formula 11 to Formula 13, since thereby higher effect is obtained. R41 and R43 may be the same type of group, or may be a group different from each other. The same is applied to R51 to R53, R61, and R62. However, the compounds shown in Formula 11 to Formula 13 are not limited to the after-mentioned compounds and may be other compound.

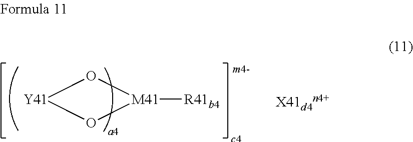

In the formula, X41 is a Group 1 element or a Group 2 element in the long period periodic table or aluminum. M41 is a transition metal, a Group 13 element, a Group 14 element, or a Group 15 element in the long period periodic table. R41 is a halogen group. Y41 is —C(═O)—R42-C(═O)—, —C(═O)—CR43₂-, or —C(═O)—C(═O)—. R42 is an alkylene group, a halogenated alkylene group, an arylene group, or a halogenated arylene group. R43 is an alkyl group, a halogenated alkyl group, an aryl group, or a halogenated aryl group. a4 is one of integer numbers 1 to 4. b4 is 0, 2, or 4. c4, d4, m4, and n4 are one of integer numbers 1 to 3.

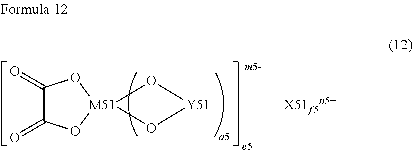

In the formula, X51 is a Group 1 element or a Group 2 element in the long period periodic table. M51 is a transition metal element, a Group 13 element, a Group 14 element, or a Group 15 element in the long period periodic table. Y51 is —C(═O)—(CR51₂)_{b5}-C(═O)—, —R53₂C—(CR52₂)_{c5}-C(═O)—, —R53₂C—(CR52₂)_{c5}-CR53₂-, —R53₂C—(CR52₂)_{c5}-S(═O)₂—, —S(═O)₂—(CR52₂)_{d5}-S(═O)₂—, or —C(═O)—(CR52₂)_{d5}-S(═O)₂—. R51 and R53 are a hydrogen group, an alkyl group, a halogen group, or a halogenated alkyl group. At least one of R51 and R53 is respectively the halogen group or the halogenated alkyl group. R52 is a hydrogen group, an alkyl group, a halogen group, or a halogenated alkyl group. a5, e5, and n5 are an integer number 1 or 2. b5 and d5 are one of integer numbers 1 to 4. c5 is one of integer numbers 0 to 4. f5 and m5 are one of integer numbers 1 to 3.

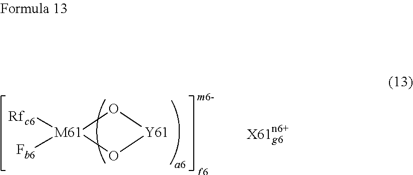

In the formula, X61 is a Group 1 element or a Group 2 element in the long period periodic table. M61 is a transition metal, a Group 13 element, a Group 14 element, or a Group 15 element in the long period periodic table. Rf is a fluorinated alkyl group with the carbon number from 1 to 10 both inclusive or a fluorinated aryl group with the carbon number from 1 to 10 both inclusive. Y61 is —C(═O)—(CR61₂)_{d6}-C(═O)—, —R62₂C—(CR61₂)_{d6}-C(═O)—, —R62₂C—(CR61₂)_{d6}-CR62₂—, —R62₂C—(CR61₂)_{d6}-S(═O)₂—, (═O)₂—(CR61₂)ₑ₆-S(═O)₂—, or —C(═O)—(CR61₂)ₑ₆-S(═O)₂—. R61 is a hydrogen group, an alkyl group, a halogen group, or a halogenated alkyl group. R62 is a hydrogen group, an alkyl group, a halogen group, or a halogenated alkyl group, and at least one thereof is the halogen group or the halogenated alkyl group. a6, f6, and n6 are integer number 1 or 2. b6, c6, and e6 are one of integer numbers 1 to 4. d6 is one of integer numbers 0 to 4. g6 and m6 are one of integer numbers 1 to 3.

Group 1 element represents hydrogen, lithium, sodium, potassium, rubidium, cesium, and francium. Group 2 element represents beryllium, magnesium, calcium, strontium, barium, and radium. Group 13 element represents boron, aluminum, gallium, indium, and thallium. Group 14 element represents carbon, silicon, germanium, tin, and lead. Group 15 element represents nitrogen, phosphorus, arsenic, antimony, and bismuth.

Examples of the compound shown in Formula 11 include compounds expressed by Formula (11-1) to Formula (11-6). Examples of the compound shown in Formula 12 include compounds shown in Formula (12-1) to Formula (12-8). Examples of the compound shown in Formula 13 include a compound shown in Formula (13-1).

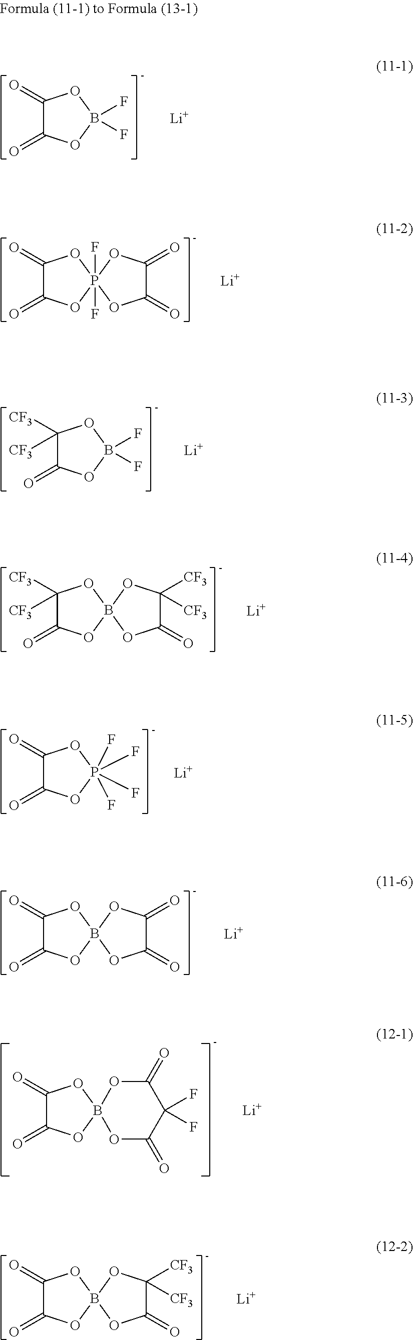

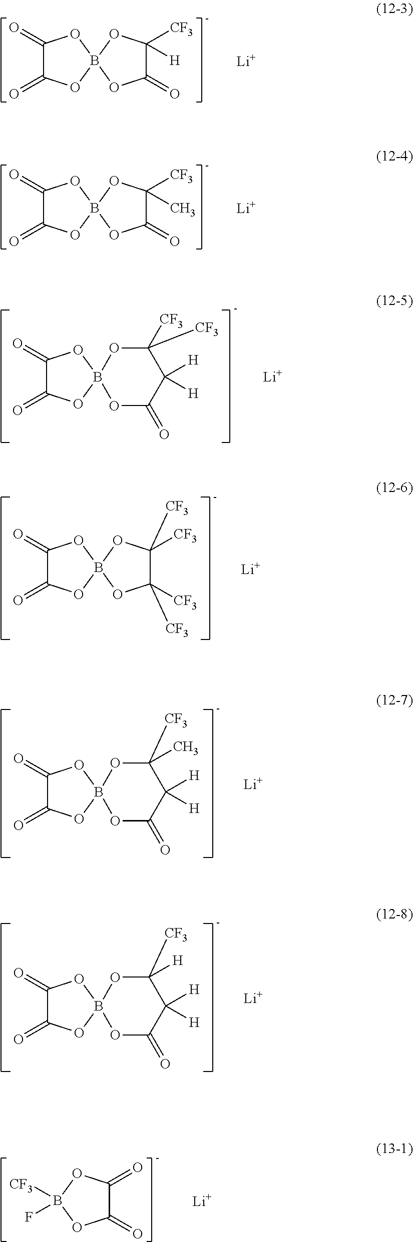

Further, the electrolyte salt preferably contains one or more of the compounds expressed by Formula 14 to Formula 16, since thereby higher effect is obtained. m and n may be the same value or a value different from each other. The same is applied to p, q, and r. The compounds shown in Formula 14 to Formula 16 are not limited to compounds described below and may be other compound.

Formula 14

LiN(CₘF₂ₘ₊₁SO₂)(CₙF₂ₙ₊₁SO₂) (14)

In the formula, m and n are an integer number greater than 1 or equal to 1.

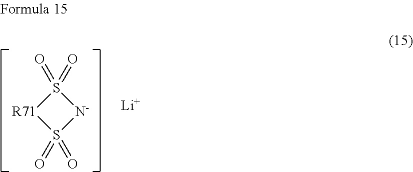

In the formula, R71 is a straight chain or branched perfluoro alkylene group with the carbon number from 2 to 4 both inclusive.

Formula 16

LiC(CₚF₂ₚ₊₁SO₂)(C_{q}F_{2q+}1SO2)(CᵣF₂ᵣ₊₁SO₂) (16)

In the formula, p, q, and r are an integer number greater than 1 or equal to 1.

The compound shown in Formula 14 is a chain imide compound. Examples of the chain imide compound include the following compounds. That is, examples thereof include lithium bis(trifluoromethanesulfonyl)imide (LiN(CF₃SO₂)₂) and lithium bis(pentafluoroethanesulfonyl)imide (LiN(C₂F₅SO₂)₂). Further examples thereof include lithium(trifluoromethanesulfonyl)(pentafluoroethanesulfonyl)imide (LiN(CF₃SO₂)(C₂F₅SO₂)). Further examples thereof include lithium(trifluoromethanesulfonyl)(heptafluoropropanesulfonyl)imide (LiN(CF₃SO₂)(C₃F₇SO₂)). Further examples thereof include lithium(trifluoromethanesulfonyl)(nonafluorobutanesulfonyl)imide (LiN(CF₃SO₂)(C₄F₉SO₂)).

The compound shown in Formula 15 is a cyclic imide compound. Examples of the cyclic imide compound include the compounds expressed by Formula (15-1) to Formula (15-4).

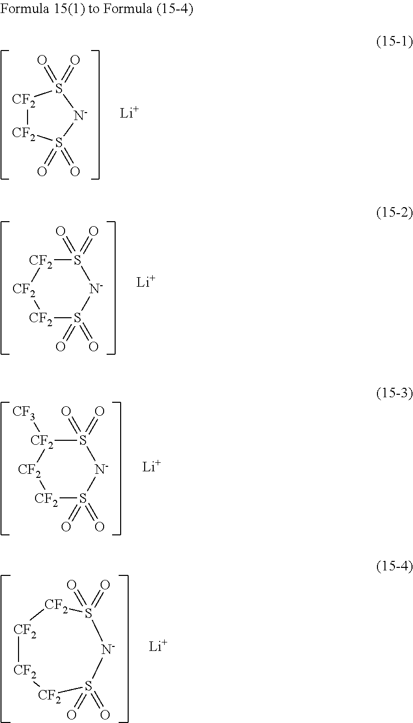

The compound shown in Formula 16 is a chain methyde compound. Examples of the chain methyde compound include lithium tris(trifluoromethanesulfonyl)methyde (LiC(CF₃SO₂)₃).

The content of the electrolyte salt is preferably from 0.3 mol/kg to 3.0 mol/kg both inclusive with respect to the nonaqueous solvent, since thereby high ion conductivity is obtained.

The electrolytic solution contains one or more nitrogen-containing organic anions and one or more fluorine-containing inorganic anions together with lithium ions. Thus, compared to a case that the electrolytic solution contains only one of the nitrogen-containing organic anion and the fluorine-containing inorganic anion, the chemical stability is improved. Therefore, since decomposition reaction of the electrolytic solution is inhibited at the time of charge and discharge, the electrolytic solution is able to contribute to improving performance of a lithium secondary battery using such an electrolytic solution. Specifically, superior cycle characteristics, superior storage characteristics, and superior load characteristics are able to be obtained

In particular, since the nitrogen-containing organic anion is contained in the electrolytic solution at a ratio from 0.001 mol to 0.5 mol both inclusive per 1 mol of the fluorine-containing inorganic anion, higher effect is able to be obtained.

2. Lithium Secondary Battery

Next, a description will be given of application examples of the foregoing electrolytic solution. The electrolytic solution is used for a lithium secondary battery, for example, as follows.

2-1. Lithium Ion Secondary Battery (Cylindrical Type)

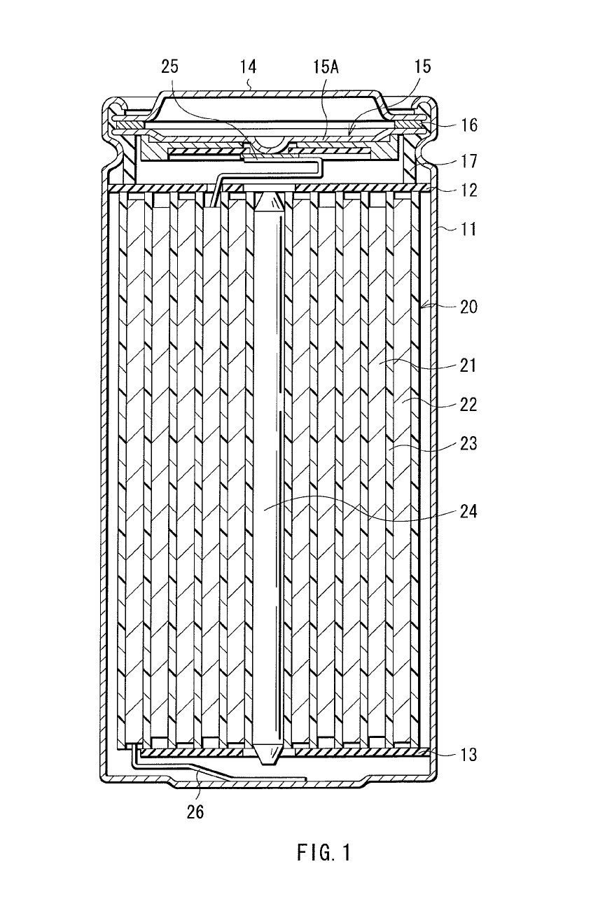

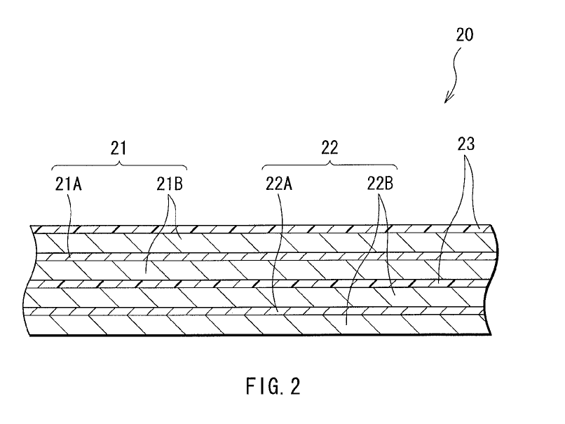

FIG. 1 and FIG. 2 illustrate a cross sectional structure of a lithium ion secondary battery (cylindrical type). FIG. 2 illustrates an enlarged part of a spirally wound electrode body 20 illustrated in FIG. 1. In the lithium ion secondary battery, the anode capacity is expressed by insertion and extraction of lithium ion.

Whole Structure of the Secondary Battery

The secondary battery mainly contains a spirally wound electrode body 20 and a pair of insulating plates 12 and 13 inside a battery can 11 in the shape of an approximately hollow cylinder. The spirally wound electrode body 20 is a spirally wound laminated body in which a cathode 21 and an anode 22 are layered with a separator 23 in between and are spirally wound.

The battery can 11 has a hollow structure in which one end of the battery can 11 is opened and the other end thereof is closed. The battery can 11 is made of, for example, iron, aluminum, an alloy thereof or the like. In the case where the battery can 11 is made of iron, for example, plating of nickel or the like may be provided on the surface of the battery can 11. The pair of insulating plates 12 and 13 is arranged to sandwich the spirally wound electrode body 20 in between from the upper and the lower sides, and to extend perpendicularly to the spirally wound periphery face.

At the open end of the battery can 11, a battery cover 14, a safety valve mechanism 15, and a PTC (Positive Temperature Coefficient) device 16 are attached by being caulked with a gasket 17. Inside of the battery can 11 is hermetically sealed. The battery cover 14 is made of, for example, a material similar to that of the battery can 11. The safety valve mechanism 15 and the PTC device 16 are provided inside the battery cover 14. The safety valve mechanism 15 is electrically connected to the battery cover 14 through the PTC device 16. In the safety valve mechanism 15, in the case where the internal pressure becomes a certain level or more by internal short circuit, external heating or the like, a disk plate 15A flips to cut the electric connection between the battery cover 14 and the spirally wound electrode body 20. As temperature rises, the PTC device 16 increases the resistance and thereby abnormal heat generation resulting from a large current is prevented. The gasket 17 is made of, for example, an insulating material. The surface of the gasket 17 may be coated with, for example, asphalt.

In the center of the spirally wound electrode body 20, a center pin 24 may be inserted. A cathode lead 25 made of a conductive material such as aluminum is connected to the cathode 21, and an anode lead 26 made of a conductive material such as nickel is connected to the anode 22. The cathode lead 25 is electrically connected to the battery cover 14 by, for example, being welded to the safety valve mechanism 15. The anode lead 26 is, for example, welded and thereby electrically connected to the battery can 11.

Cathode

In the cathode 21, for example, a cathode active material layer 21B is provided on both faces of a cathode current collector 21A. However, the cathode active material layer 21B may be provided only on a single face of the cathode current collector 21A.

The cathode current collector 21A is made of, for example, a conductive material such as aluminum (Al), nickel (Ni), and stainless steel.

The cathode active material layer 21B contains, as a cathode active material, one or more cathode materials capable of inserting and extracting lithium ions. According to needs, the cathode active material layer 21B may contain other material such as a cathode binder and a cathode electrical conductor.

As the cathode material, a lithium-containing compound is preferable, since thereby a high energy density is able to be obtained. Examples of the lithium-containing compounds include a composite oxide having lithium and a transition metal element as an element, and a phosphate compound containing lithium and a transition metal element as an element. Specially, a compound containing one or more of cobalt (Co), nickel, manganese (Mn), and iron (Fe) as a transition metal element is preferable, since thereby a higher voltage is obtained. The chemical formula thereof is expressed by, for example, LiₓM1O₂ or Li_{y}M2PO₄. In the formula, M1 and M2 represent one or more transition metal elements. Values of x and y vary according to the charge and discharge state, and are generally in the range of 0.05≦x≦1.10 and 0.05≦y≦1.10.

Examples of composite oxides having lithium and a transition metal element include a lithium-cobalt composite oxide (LiₓCoO₂), a lithium-nickel composite oxide (LiₓNiO₂), and a lithium-nickel composite oxide expressed by Formula 17. Examples of phosphate compounds having lithium and a transition metal element include lithium-iron phosphate compound (LiFePO₄) and a lithium-iron-manganese phosphate compound (LiFe₁₋ᵤMnᵤPO₄ (u<1)), since thereby a high battery capacity is obtained and superior cycle characteristics are obtained.

Formula 17

LiNi₁₋xMxO2 (17)

In the formula, M is one or more of cobalt, manganese, iron, aluminum, vanadium, tin, magnesium, titanium, strontium, calcium, zirconium, molybdenum, technetium, ruthenium, tantalum, tungsten, rhenium, ytterbium, copper, zinc, barium, boron, chromium, silicon, gallium, phosphorus, antimony, and niobium. x is in the range of 0.005<x<0.5.

In addition, examples of cathode materials include an oxide, a disulfide, a chalcogenide, and a conductive polymer. Examples of oxides include titanium oxide, vanadium oxide, and manganese dioxide. Examples of disulfide include titanium disulfide and molybdenum sulfide. Examples of chalcogenide include niobium selenide. Examples of conductive polymer include sulfur, polyaniline, and polythiophene.

Examples of cathode binders include one or more of a synthetic rubber and a polymer material. Examples of the synthetic rubber include styrene butadiene rubber, fluorinated rubber, and ethylene propylene diene. Examples of the polymer material include polyvinylidene fluoride and polyimide.

Examples of cathode electrical conductors include one or more carbon materials. Examples of the carbon materials include graphite, carbon black, acetylene black, and Ketjen black. The cathode electrical conductor may be a metal material, a conductive polymer or the like as long as the material has the electric conductivity.

Anode

In the anode 22, for example, an anode active material layer 22B is provided on both faces of an anode current collector 22A. However, the anode active material layer 22B may be provided only on a single face of the anode current collector 22A.

The anode current collector 22A is made of, for example, a conductive material such as copper, nickel, and stainless steel. The surface of the anode current collector 22A is preferably roughened. Thereby, due to the so-called anchor effect, the contact characteristics between the anode current collector 22A and the anode active material layer 22B are improved. In this case, it is enough that at least the surface of the anode current collector 22A in the area opposed to the anode active material layer 22B is roughened. Examples of roughening methods include a method of forming fine particles by electrolytic treatment. The electrolytic treatment is a method of providing concavity and convexity by forming fine particles on the surface of the anode current collector 22A by electrolytic method in an electrolytic bath. A copper foil formed by electrolytic method is generally called “electrolytic copper foil.”

The anode active material layer 22B contains one or more anode materials capable of inserting and extracting lithium ions as an anode active material, and may also contain other material such as an anode binder and an anode electrical conductor according to needs. Details of the anode binder and the anode electrical conductor are, for example, respectively similar to those of the cathode binder and the cathode electrical conductor. In the anode active material layer 22B, for example, the chargeable capacity of the anode material is preferably larger than the discharge capacity of the cathode 21 in order to prevent unintentional precipitation of lithium metal at the time of charge and discharge.

Examples of anode materials include a carbon material. In the carbon material, crystal structure change at the time of insertion and extraction of lithium ions is extremely small. Thus, the carbon material provides a high energy density and superior cycle characteristics, and functions as an anode electrical conductor as well. Examples of carbon materials include graphitizable carbon, non-graphitizable carbon in which the spacing of (002) plane is 0.37 nm or more, and graphite in which the spacing of (002) plane is 0.34 nm or less. More specifically, examples of carbon materials include pyrolytic carbon, coke, glassy carbon fiber, an organic polymer compound fired body, activated carbon, and carbon black. Of the foregoing, the coke includes pitch coke, needle coke, and petroleum coke. The organic polymer compound fired body is obtained by firing and carbonizing a phenol resin, a furan resin or the like at appropriate temperature. The shape of the carbon material may be any of a fibrous shape, a spherical shape, a granular shape, and a scale-like shape.

Examples of anode materials include a material (metal material) having one or more of metal elements and metalloid elements as an element. Such a metal material is preferably used, since a high energy density is able to be thereby obtained. Such a metal material may be a simple substance, an alloy, or a compound of a metal element or a metalloid element, may be two or more thereof, or may have one or more phases thereof at least in part. In the application, “alloy” includes a material containing one or more metal elements and one or more metalloid elements, in addition to a material composed of two or more metal elements. Further, “alloy” may contain a nonmetallic element. The texture thereof includes a solid solution, a eutectic crystal (eutectic mixture), an intermetallic compound, and a texture in which two or more thereof coexist.

The foregoing metal element or the foregoing metalloid element is, for example, a metal element or a metalloid element capable of forming an alloy with lithium. Specifically, the foregoing metal element or the foregoing metalloid element is one or more of the following elements. That is, the foregoing metal element or the foregoing metalloid element is one or more of magnesium (Mg), boron (B), aluminum, gallium (Ga), indium (In), silicon (Si), germanium (Ge), tin (Sn), lead (Pb), bismuth (Bi), cadmium (Cd), silver (Ag), zinc (Zn), hafnium (Hf), zirconium (Zr), yttrium (Y), palladium (Pd), and platinum (Pt). Specially, at least one of silicon and tin is preferably used. Silicon and tin have the high ability to insert and extract lithium ion, and thus are able to provide a high energy density.

A material containing at least one of silicon and tin may be, for example, a simple substance, an alloy, or a compound of silicon or tin; two or more thereof; or a material having one or more phases thereof at least in part.

Examples of alloys of silicon include a material having one or more of the following elements as an element other than silicon. Such an element other than silicon is tin, nickel, copper, iron, cobalt, manganese, zinc, indium, silver, titanium, germanium, bismuth, antimony, and chromium. Examples of compounds of silicon include a compound containing oxygen or carbon as an element other than silicon. The compounds of silicon may have one or more of the elements described for the alloys of silicon as an element other than silicon.

Examples of an alloy or a compound of silicon include SiB₄, SiB₆, Mg₂Si, Ni₂Si, TiSi₂, MoSi₂, CoSi₂, NiSi₂, CaSi₂, CrSi₂, Cu₅Si, FeSi₂, MnSi₂, NbSi₂, TaSi₂, VSi₂, WSi₂, ZnSi₂, SiC, Si₃N₄, Si₂N₂O, SiOᵥ (0<v≦2), and LiSiO.

Examples of alloys of tin include a material having one or more of the following elements as an element other than tin. Such an element is silicon, nickel, copper, iron, cobalt, manganese, zinc, indium, silver, titanium, germanium, bismuth, antimony, or chromium. Examples of compounds of tin include a material having oxygen or carbon as an element. The compounds of tin may contain one or more elements described for the alloys of tin as an element other than tin. Examples of alloys or compounds of tin include SnO_{w} (0<w≦2), SnSiO₃, LiSnO, and Mg₂Sn.

In particular, as a material having silicon, for example, the simple substance of silicon is preferable, since a high battery capacity, superior cycle characteristics and the like are thereby obtained. “Simple substance” only means a general simple substance (may contain a slight amount of impurity), and does not necessarily mean a substance with purity 100%.

Further, as a material having tin, for example, a material containing a second element and a third element in addition to tin as a first element is preferable. The second element is, for example, one or more of the following elements. That is, the second element is one or more of cobalt, iron, magnesium, titanium, vanadium, chromium, manganese, nickel, copper, zinc, gallium, zirconium, niobium, molybdenum, silver, indium, cerium (Ce), hafnium, tantalum, tungsten (W), bismuth, and silicon. The third element is, for example, one or more of boron, carbon, aluminum, and phosphorus. In the case where the second element and the third element are contained, a high battery capacity, superior cycle characteristics and the like are obtained.

Specially, a material having tin, cobalt, and carbon (SnCoC-containing material) is preferable. As the composition of the SnCoC-containing material, for example, the carbon content is from 9.9 mass % to 29.7 mass % both inclusive, and the ratio of tin and cobalt contents (Co/(Sn+Co)) is from 20 mass % to 70 mass % both inclusive, since a high energy density is obtained in such a composition range.

It is preferable that the SnCoC-containing material has a phase containing tin, cobalt, and carbon. Such a phase preferably has a low crystalline structure or an amorphous structure. The phase is a reaction phase capable of being reacted with lithium. Due to existence of the reaction phase, superior characteristics are able to be obtained. The half bandwidth of the diffraction peak obtained by X-ray diffraction of the phase is preferably 1.0 deg or more based on diffraction angle of 20 in the case where CuKα ray is used as a specific X ray, and the trace speed is 1 deg/min. Thereby, lithium ions are more smoothly inserted and extracted, and reactivity with the electrolytic solution is decreased. In some cases, the SnCoC-containing material has a phase containing a simple substance or part of the respective elements in addition to the low crystalline or amorphous phase.

Whether or not the diffraction peak obtained by X-ray diffraction corresponds to the reaction phase capable of being reacted with lithium is able to be easily determined by comparison between X-ray diffraction charts before and after electrochemical reaction with lithium. For example, if the position of the diffraction peak after electrochemical reaction with lithium is changed from the position of the diffraction peak before electrochemical reaction with lithium, the obtained diffraction peak corresponds to the reaction phase capable of being reacted with lithium. In this case, for example, the diffraction peak of the low crystalline or amorphous reaction phase is observed in the range of 2θ=20 to 50 deg. Such a reaction phase has the foregoing element, and the low crystalline or amorphous structure may result from existence of carbon.

In the SnCoC-containing material, at least part of carbon as an element is preferably bonded to a metal element or a metalloid element as other element, since thereby cohesion or crystallization of tin or the like is inhibited. The bonding state of elements is able to be checked by, for example, X-ray Photoelectron Spectroscopy (XPS). In a commercially available apparatus, for example, as a soft X ray, Al—Kα ray, Mg—Kα ray or the like is used. In the case where at least part of carbon is bonded to a metal element, a metalloid element or the like, the peak of a synthetic wave of 1s orbit of carbon (C is) is shown in a region lower than 284.5 eV. In the apparatus, energy calibration is made so that the peak of 4f orbit of gold atom (Au4f) is obtained in 84.0 eV. At this time, in general, since surface contamination carbon exists on the material surface, the peak of C1s of the surface contamination carbon is regarded as 284.8 eV, which is used as the energy standard. In XPS measurement, the waveform of the peak of C1s is obtained as a form including the peak of the surface contamination carbon and the peak of carbon in the SnCoC-containing material. Thus, for example, analysis is made by using commercially available software to isolate both peaks from each other. In the waveform analysis, the position of a main peak existing on the lowest bound energy is the energy reference (284.8 eV).

The SnCoC-containing material may further contain other element according to needs. Examples of other elements include one or more of silicon, iron, nickel, chromium, indium, niobium, germanium, titanium, molybdenum, aluminum, phosphorus, gallium, and bismuth.

In addition to the SnCoC-containing material, a material containing tin, cobalt, iron, and carbon (SnCoFeC-containing material) is also preferable. The composition of the SnCoFeC-containing material is able to be arbitrarily set. For example, a composition in which the iron content is set small is as follows. That is, the carbon content is from 9.9 mass % to 29.7 mass % both inclusive, the iron content is from 0.3 mass % to 5.9 mass % both inclusive, and the ratio of contents of tin and cobalt (Co/(Sn+Co)) is from 30 mass % to 70 mass % both inclusive. Further, for example, a composition in which the iron content is set large is as follows. That is, the carbon content is from 11.9 mass % to 29.7 mass % both inclusive, the ratio of contents of tin, cobalt, and iron ((Co+Fe)/(Sn+Co+Fe)) is from 26.4 mass % to 48.5 mass % both inclusive, and the ratio of contents of cobalt and iron (Co/(Co+Fe)) is from 9.9 mass % to 79.5 mass % both inclusive. In such a composition range, a high energy density is obtained. The physical property and the like (half-width) of the SnCoFeC-containing material are similar to those of the foregoing SnCoC-containing material.

Further, examples of other anode materials include a metal oxide and a polymer compound. The metal oxide is, for example, iron oxide, ruthenium oxide, molybdenum oxide or the like. The polymer compound is, for example, polyacetylene, polyaniline, polypyrrole or the like.

The anode active material layer 22B is formed by, for example, coating method, vapor-phase deposition method, liquid-phase deposition method, spraying method, firing method (sintering method), or a combination of two or more of these methods. Coating method is a method in which, for example, a particulate anode active material is mixed with a binder or the like, the mixture is dispersed in a solvent such as an organic solvent, and the anode current collector is coated with the resultant. Examples of vapor-phase deposition methods include physical deposition method and chemical deposition method. Specifically, examples thereof include vacuum evaporation method, sputtering method, ion plating method, laser ablation method, thermal CVD (Chemical Vapor Deposition) method, and plasma CVD method. Examples of liquid-phase deposition methods include electrolytic plating method and electroless plating method. Spraying method is a method in which the anode active material is sprayed in a fused state or a semi-fused state. Firing method is, for example, a method in which after the anode current collector is coated by a procedure similar to that of coating method, heat treatment is provided at temperature higher than the melting point of the anode binder or the like. Examples of firing methods include a known technique such as atmosphere firing method, reactive firing method, and hot press firing method.

Separator

The separator 23 separates the cathode 21 from the anode 22, and passes lithium ions while preventing current short circuit resulting from contact of both electrodes. The separator 23 is impregnated with the foregoing electrolytic solution as a liquid electrolyte. The separator 23 is formed from, for example, a porous film made of a synthetic resin or ceramics. The separator 23 may be a laminated film composed of two or more porous films. Examples of synthetic resin include polytetrafluoroethylene, polypropylene, and polyethylene.

### Operation of the Secondary Battery

In the secondary battery, at the time of charge, for example, lithium ions extracted from the cathode 21 are inserted in the anode 22 through the electrolytic solution. Meanwhile, at the time of discharge, for example, lithium ions extracted from the anode 22 are inserted in the cathode 21 through the electrolytic solution.

Method of Manufacturing the Secondary Battery

The secondary battery is manufactured, for example, by the following procedure.

First, the cathode 21 is formed. First, a cathode active material is mixed with a cathode binder, a cathode electrical conductor or the like according to needs to prepare a cathode mixture, which is subsequently dispersed in a solvent such as an organic solvent to obtain paste cathode mixture slurry. Subsequently, both faces of the cathode current collector 21A are coated with the cathode mixture slurry, which is dried to form the cathode active material layer 21B. Finally, the cathode active material layer 21B is compression-molded by a rolling press machine or the like while being heated if necessary. In this case, the resultant may be compression-molded over several times.

Next, the anode 22 is formed by a procedure similar to that of the foregoing cathode 21. In this case, an anode active material is mixed with an anode binder, an anode electrical conductor or the like according to needs to prepare an anode mixture, which is subsequently dispersed in a solvent to form paste anode mixture slurry. Subsequently, both faces of the anode current collector 22A are coated with the anode mixture slurry, which is dried to form the anode active material layer 22B. After that, the anode active material layer 22B is compression-molded according to needs.

The anode 22 may be formed by a procedure different from that of the cathode 21. In this case, for example, the anode material is deposited on both faces of the anode current collector 22A by vapor-phase deposition method such as evaporation method to form the anode active material layer 22B.

Finally, the secondary battery is assembled by using the cathode 21 and the anode 22. First, the cathode lead 25 is attached to the cathode current collector 21A by welding or the like, and the anode lead 26 is attached to the anode current collector 22A by welding or the like. Subsequently, the cathode 21 and the anode 22 are layered with the separator 23 in between and spirally wound, and thereby the spirally wound electrode body 20 is formed. After that, the center pin 24 is inserted in the center of the spirally wound electrode body. Subsequently, the spirally wound electrode body 20 is sandwiched between the pair of insulating plates 12 and 13, and contained in the battery can 11. In this case, the end of the cathode lead 25 is attached to the safety valve mechanism 15 by welding or the like, and the end of the anode lead 26 is attached to the battery can 11 by welding or the like. Subsequently, the electrolytic solution is injected into the battery can 11, and the separator 23 is impregnated with the electrolytic solution. Finally, at the open end of the battery can 11, the battery cover 14, the safety valve mechanism 15, and the PTC device 16 are fixed by being caulked with the gasket 17. The secondary battery illustrated in FIG. 1 and FIG. 2 is thereby completed.

Since the lithium ion secondary battery includes the foregoing electrolytic solution, decomposition reaction of the electrolytic solution at the time of charge and discharge is inhibited. Therefore, superior cycle characteristics, superior storage characteristics, and superior load characteristics are able to be obtained. In particular, in the case where the metal material advantageous to realizing a high capacity as an anode active material of the anode 22 is used, the characteristics are improved. Thus, higher effect is able to be obtained than in a case that a carbon material or the like is used. Other effect for the lithium ion secondary battery is similar to that of the foregoing electrolytic solution.

2-2. Lithium Ion Secondary Battery (Laminated Film Type)

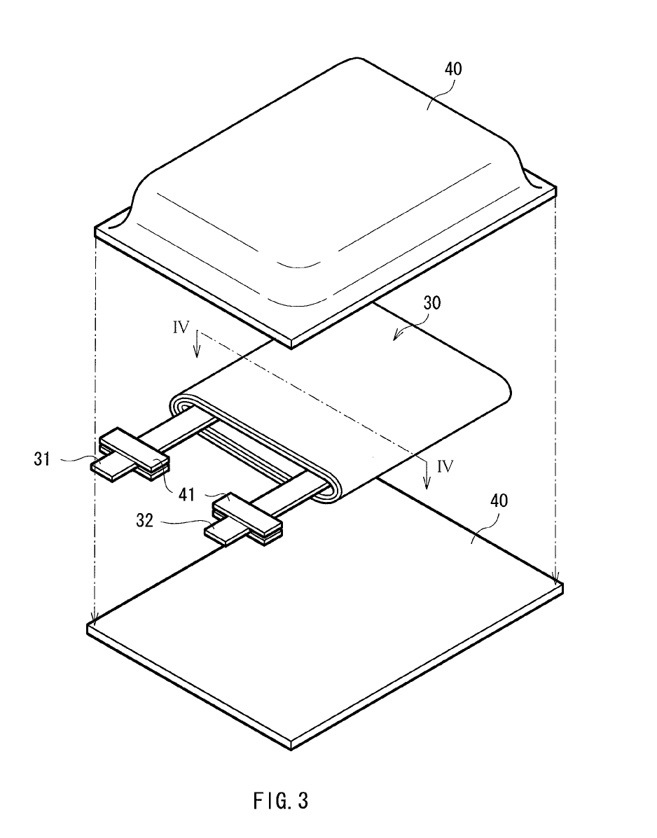

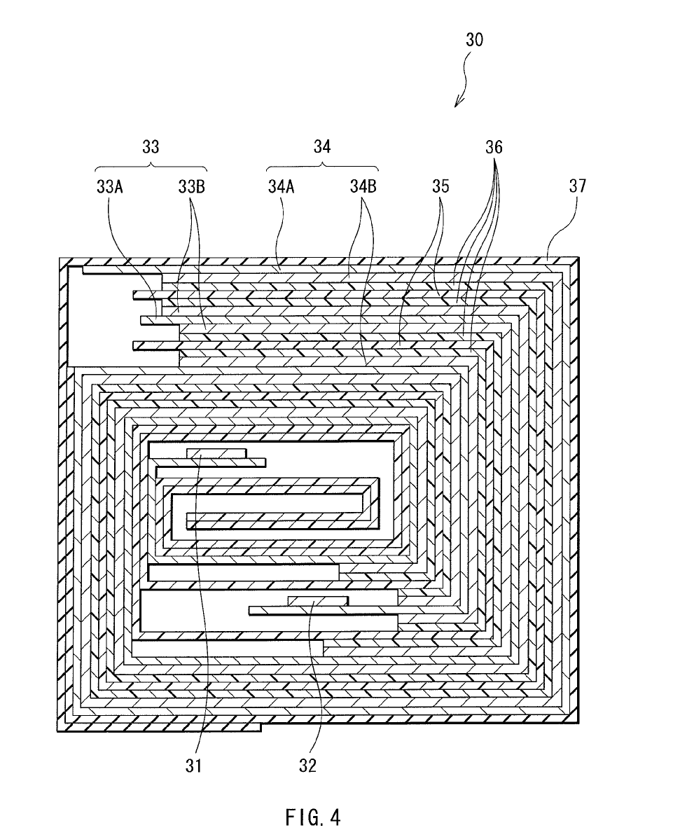

FIG. 3 illustrates an exploded perspective structure of a lithium ion secondary battery (laminated film type). FIG. 4 illustrates an enlarged cross section taken along line IV-IV of a spirally wound electrode body 30 illustrated in FIG. 3.

In the secondary battery, a spirally wound electrode body 30 is contained in a film package member 40 mainly. The spirally wound electrode body 30 is a spirally wound laminated body in which a cathode 33 and an anode 34 are layered with a separator 35 and an electrolyte layer 36 in between and are spirally wound. A cathode lead 31 is attached to the cathode 33, and an anode lead 32 is attached to the anode 34. The outermost peripheral section of the spirally wound electrode body 30 is protected by a protective tape 37.

The cathode lead 31 and the anode lead 32 are, for example, respectively led out from inside to outside of the package member 40 in the same direction. The cathode lead 31 is made of, for example, a conductive material such as aluminum, and the anode lead 32 is made of, for example, a conductive material such as copper, nickel, and stainless steel. These materials are in the shape of, for example, a thin plate or mesh.

The package member 40 is a laminated film in which, for example, a fusion bonding layer, a metal layer, and a surface protective layer are layered in this order. In the laminated film, for example, the respective outer edges of the fusion bonding layer of two films are bonded to each other by fusion bonding, an adhesive or the like so that the fusion bonding layer and the spirally wound electrode body 30 are opposed to each other. Examples of fusion bonding layers include a film made of polyethylene, polypropylene or the like. Examples of metal layers include an aluminum foil. Examples of surface protective layers include a film made of nylon, polyethylene terephthalate or the like.

Specially, as the package member 40, an aluminum laminated film in which a polyethylene film, an aluminum foil, and a nylon film are layered in this order is preferable. However, the package member 40 may be made of a laminated film having other laminated structure, a polymer film such as polypropylene, or a metal film.

An adhesive film 41 to protect from entering of outside air is inserted between the package member 40 and the cathode lead 31, the anode lead 32. The adhesive film 41 is made of a material having contact characteristics with respect to the cathode lead 31 and the anode lead 32. Examples of such a material include, for example, a polyolefin resin such as polyethylene, polypropylene, modified polyethylene, and modified polypropylene.

In the cathode 33, a cathode active material layer 33B is provided on both faces of a cathode current collector 33A. In the anode 34, for example, an anode active material layer 34B is provided on both faces of an anode current collector 34A. The structures of the cathode current collector 33A, the cathode active material layer 33B, the anode current collector 34A, and the anode active material layer 34B are respectively similar to the structures of the cathode current collector 21A, the cathode active material layer 21B, the anode current collector 22A and the anode active material layer 22B. The structure of the separator 35 is similar to the structure of the separator 23.

In the electrolyte layer 36, an electrolytic solution is held by a polymer compound. The electrolyte layer 36 may contain other material such as an additive according to needs. The electrolyte layer 36 is a so-called gel electrolyte. The gel electrolyte is preferable, since high ion conductivity (for example, 1 mS/cm or more at room temperature) is obtained and liquid leakage of the electrolytic solution is prevented.

Examples of polymer compounds include one or more of the following polymer materials. That is, examples thereof include polyacrylonitrile, polyvinylidene fluoride, polytetrafluoroethylene, polyhexafluoropropylene, polyethylene oxide, polypropylene oxide, polyphosphazene, polysiloxane, and polyvinyl fluoride. Further, examples thereof include polyvinyl acetate, polyvinyl alcohol, polymethacrylic acid methyl, polyacrylic acid, polymethacrylic acid, styrene-butadiene rubber, nitrile-butadiene rubber, polystyrene, and polycarbonate. Further, examples thereof include a copolymer of vinylidene fluoride and hexafluoropropylene. Specially, polyvinylidene fluoride or the copolymer of vinylidene fluoride and hexafluoropropylene is preferable, since such a polymer compound is electrochemically stable.

The composition of the electrolytic solution is similar to the composition of the electrolytic solution described in the cylindrical type secondary battery. However, in the electrolyte layer 36 as the gel electrolyte, a nonaqueous solvent of the electrolytic solution means a wide concept including not only the liquid solvent but also a material having ion conductivity capable of dissociating the electrolyte salt. Therefore, in the case where the polymer compound having ion conductivity is used, the polymer compound is also included in the solvent.

Instead of the gel electrolyte layer 36, the electrolytic solution may be directly used. In this case, the separator 35 is impregnated with the electrolytic solution.

In the secondary battery, at the time of charge, for example, lithium ions extracted from the cathode 33 are inserted in the anode 34 through the electrolyte layer 36. Meanwhile, at the time of discharge, for example, lithium ions extracted from the anode 34 are inserted in the cathode 33 through the electrolyte layer 36.

The secondary battery including the gel electrolyte layer 36 is manufactured, for example, by the following three procedures.

In the first procedure, first, the cathode 33 and the anode 34 are formed by a formation procedure similar to that of the cathode 21 and the anode 22. In this case, the cathode 33 is formed by forming the cathode active material layer 33B on both faces of the cathode current collector 33A, and the anode 34 is formed by forming the anode active material layer 34B on both faces of the anode current collector 34A. Subsequently, a precursor solution containing an electrolytic solution, a polymer compound, and a solvent such as an organic solvent is prepared. After that, the cathode 33 and the anode 34 are coated with the precursor solution to form the gel electrolyte layer 36. Subsequently, the cathode lead 31 is attached to the cathode current collector 33A and the anode lead 32 is attached to the anode current collector 34A by welding method or the like. Subsequently, the cathode 33 and the anode 34 provided with the electrolyte layer 36 are layered with the separator 35 in between and spirally wound to form the spirally wound electrode body 30. After that, the protective tape 37 is adhered to the outermost periphery thereof. Finally, after the spirally wound electrode body 30 is sandwiched between two pieces of film-like package members 40, outer edges of the package members 40 are contacted by thermal fusion bonding method or the like to enclose the spirally wound electrode body 30 into the package members 40. In this case, the adhesive films 41 are inserted between the cathode lead 31, the anode lead 32 and the package member 40.

In the second procedure, first, the cathode lead 31 is attached to the cathode 33, and the anode lead 32 is attached to the anode 34. Subsequently, the cathode 33 and the anode 34 are layered with the separator 35 in between and spirally wound to form a spirally wound body as a precursor of the spirally wound electrode body 30. After that, the protective tape 37 is adhered to the outermost periphery thereof. Subsequently, after the spirally wound body is sandwiched between two pieces of the film-like package members 40, the outermost peripheries except for one side are bonded by thermal fusion bonding method or the like to obtain a pouched state, and the spirally wound body is contained in the pouch-like package member 40. Subsequently, a composition of matter for electrolyte containing an electrolytic solution, a monomer as a raw material for the polymer compound, a polymerization initiator, and if necessary other material such as a polymerization inhibitor is prepared, which is injected into the pouch-like package member 40. After that, the opening of the package member 40 is hermetically sealed by using thermal fusion bonding method or the like. Finally, the monomer is thermally polymerized to obtain a polymer compound. Thereby, the gel electrolyte layer 36 is formed.

In the third procedure, the spirally wound body is firstly formed and contained in the pouch-like package member 40 in the same manner as that of the foregoing second procedure, except that the separator 35 with both faces coated with a polymer compound is used. Examples of polymer compounds with which the separator 35 is coated include a polymer containing vinylidene fluoride as a component (a homopolymer, a copolymer, a multicomponent copolymer or the like). Specific examples thereof include polyvinylidene fluoride, a binary copolymer containing vinylidene fluoride and hexafluoropropylene as a component, and a ternary copolymer containing vinylidene fluoride, hexafluoropropylene, and chlorotrifluoroethylene as a component. In addition to the polymer containing vinylidene fluoride as a component, another one or more polymer compounds may be used. Subsequently, an electrolytic solution is prepared and injected into the package member 40. After that, the opening of the package member 40 is sealed by thermal fusion bonding method or the like. Finally, the resultant is heated while a weight is applied to the package member 40, and the separator 35 is contacted with the cathode 33 and the anode 34 with the polymer compound in between. Thereby, the polymer compound is impregnated with the electrolytic solution, and accordingly the polymer compound is gelated to form the electrolyte layer 36.

In the third procedure, the swollenness of the battery is inhibited compared to the first procedure. Further, in the third procedure, the monomer, the solvent and the like as a raw material of the polymer compound are hardly left in the electrolyte layer 36 compared to the second procedure. Thus, the formation step of the polymer compound is favorably controlled. Therefore, sufficient contact characteristics are obtained between the cathode 33/the anode 34/the separator 35 and the electrolyte layer 36.

According to the lithium ion secondary battery, the electrolyte layer 36 contains the foregoing electrolytic solution. Therefore, superior cycle characteristics, superior storage characteristics, and superior load characteristics are able to be obtained by action similar to that of the cylindrical type secondary battery. Other effects of the lithium ion secondary battery are similar to those of the electrolytic solution.

2-3. Lithium Metal Secondary Battery

A secondary battery hereinafter described is a lithium metal secondary battery in which the anode capacity is expressed by precipitation and dissolution of lithium metal. The secondary battery has a structure similar to that of the foregoing lithium ion secondary battery (cylindrical type), except that the anode active material layer 22B is formed from lithium metal, and is manufactured by a procedure similar to that of the foregoing lithium ion secondary battery (cylindrical type).

In the secondary battery, lithium metal is used as an anode active material, and thereby a higher energy density is able to be obtained. It is possible that the anode active material layer 22B already exists at the time of assembling, or the anode active material layer 22B does not exist at the time of assembling and is to be composed of lithium metal to be precipitated at the time of charge. Further, it is possible that the anode active material layer 22B is used as a current collector as well, and the anode current collector 22A is omitted.

In the secondary battery, at the time of charge, for example, lithium ions extracted from the cathode 21 are precipitated as lithium metal on the surface of the anode current collector 22A through the electrolytic solution. Meanwhile, at the time of discharge, for example, lithium metal is eluted as lithium ions from the anode active material layer 22B, and is inserted in the cathode 21 through the electrolytic solution.

The lithium metal secondary battery includes the foregoing electrolytic solution. Therefore, superior cycle characteristics, superior storage characteristics, and superior load characteristics are able to be obtained by operation similar to that of the lithium ion secondary battery. Other effects of the lithium metal secondary battery are similar to those of the electrolytic solution. The foregoing lithium metal secondary battery is not limited to the cylindrical type secondary battery, but may be a laminated film type secondary battery. In this case, similar effect is able to be also obtained.

3. Application of the Lithium Secondary Battery

Next, a description will be given of an application example of the foregoing lithium secondary battery.

Applications of the lithium secondary battery are not particularly limited as long as the lithium secondary battery is applied to a machine, a device, an instrument, an equipment, a system (collective entity of a plurality of devices and the like) or the like that is able to use the lithium secondary battery as a drive power source, an electric power storage source for electric power storage or the like. In the case where the lithium secondary battery is used as a power source, the lithium secondary battery may be used as a main power source (power source used preferentially), or an auxiliary power source (power source used instead of a main power source or used being switched from the main power source). In the latter case, the main power source type is not limited to the lithium secondary battery.

Examples of applications of the lithium secondary battery include portable electronic devices such as a video camera, a digital still camera, a mobile phone, a notebook personal computer, a cordless phone, a headphone stereo, a portable radio, a portable television, and a Personal Digital Assistant (PDA); a portable lifestyle device such as an electric shaver; a storage equipment such as a backup power source and a memory card; an electric power tool such as an electric drill and an electric saw; a medical electronic device such as a pacemaker and a hearing aid; a vehicle such as an electrical vehicle (including a hybrid car); and an electric power storage system such as a home battery system for storing electric power for emergency or the like.

Specially, the lithium secondary battery is effectively applied to the electric power tool, the electrical vehicle, the electric power storage system or the like. In these applications, since superior characteristics (cycle characteristics, storage characteristics, and load characteristics and the like) of the lithium secondary battery are demanded, the characteristics are able to be effectively improved by using the lithium secondary battery of the application. The electric power tool is a tool in which a moving part (for example, a drill or the like) is moved by using the lithium secondary battery as a driving power source. The electrical vehicle is a car that acts (runs) by using the lithium secondary battery as a driving power source. As described above, a car including the drive source as well other than the lithium secondary battery (hybrid car or the like) may be adopted. The electric power storage system is a system using the lithium secondary battery as an electric power storage source. For example, in a home electric power storage system, electric power is stored in the lithium secondary battery as an electric power storage source, and the electric power stored in the lithium secondary battery is consumed according to needs. In the result, various devices such as home electric products become usable.

### EXAMPLES

Specific examples of the application will be described in detail.

### Examples 1-1 to 1-46

The cylindrical type lithium ion secondary batteries illustrated in FIG. 1 and FIG. 2 were fabricated by the following procedure.

First, the cathode 21 was formed. In this case, first, lithium carbonate (Li₂CO₃) and cobalt carbonate (CoCO₃) were mixed at a molar ratio of 0.5:1. After that, the mixture was fired in the air at 900 deg C. for 5 hours. Thereby, lithium-cobalt composite oxide (LiCoO₂) was obtained. Subsequently, 91 parts by mass of LiCoO₂ as a cathode active material, 6 parts by mass of graphite as a cathode electrical conductor, and 3 parts by mass of polyvinylidene fluoride as a cathode binder were mixed to obtain a cathode mixture. Subsequently, the cathode mixture was dispersed in N-methyl-2-pyrrolidone to obtain paste cathode mixture slurry. Subsequently, both faces of the cathode current collector 21A were coated with the cathode mixture slurry by a coating device, which was dried to form the cathode active material layer 21B. As the cathode current collector 21A, a strip-shaped aluminum foil (thickness: 20 μm) was used. Finally, the cathode active material layer 21B was compression-molded by a roll pressing machine.

Next, the anode 22 was formed. In this case, first, 90 parts by mass of the carbon material (artificial graphite) as an anode active material and 10 parts by mass of polyvinylidene fluoride as an anode binder were mixed to obtain an anode mixture. Subsequently, the anode mixture was dispersed in N-methyl-2-pyrrolidone to obtain paste anode mixture slurry. Subsequently, both faces of the anode current collector 22A were coated with the anode mixture slurry by using a coating device, which was dried to form the anode active material layer 22B. As the anode current collector 22A, a strip-shaped electrolytic copper foil (thickness: 15 μm) was used. Finally, the anode active material layer 22B was compression-molded by a roll pressing machine.

Next, an electrolyte salt was dissolved in a nonaqueous solvent, and an electrolytic solution was prepared so that the compositions illustrated in Table 1 and Table 2 were obtained. In this case, ethylene carbonate (EC) and dimethyl carbonate (DMC) were used as a nonaqueous solvent. The mixture ratio (weight ratio) of EC and DMC was 50:50. Further, the type of electrolyte salt and the content thereof with respect to the nonaqueous solvent were as illustrated in Table 1 and Table 2.

Finally, the secondary battery was assembled by using the cathode 21, the anode 22, and the electrolytic solution. In this case, first, the cathode lead 25 was welded to the cathode current collector 21A, and the anode lead 26 was welded to the anode current collector 22A. Subsequently, the cathode 21 and the anode 22 were layered with the separator 23 in between and spirally wound to form the spirally wound electrode body 20. After that, the center pin 24 was inserted in the center of the spirally wound electrode body. As the separator 23, a microporous polypropylene film (thickness: 25 μm) was used. Subsequently, while the spirally wound electrode body 20 was sandwiched between the pair of insulating plates 12 and 13, the spirally wound electrode body 20 was contained in the iron battery can 11 plated with nickel. At this time, the cathode lead 25 was welded to the safety valve mechanism 15, and the anode lead 26 was welded to the battery can 11. Subsequently, the electrolytic solution was injected into the battery can 11 by depressurization method, and the separator 23 was impregnated with the electrolytic solution. Finally, at the open end of the battery can 11, the battery cover 14, the safety valve mechanism 15, and the PTC device 16 were fixed by being caulked with the gasket 17. The cylindrical type secondary battery was thereby completed. In forming the secondary battery, lithium metal was prevented from being precipitated on the anode 22 at the full charged state by adjusting the thickness of the cathode active material layer 21B.

The cycle characteristics, the storage characteristics, and the load characteristics for the secondary batteries were examined. The results illustrated in Table 1 and Table 2 were obtained.

In examining the cycle characteristics, first, two cycles of charge and discharge were performed in the atmosphere at 23 deg C., and the discharge capacity was measured. Subsequently, the secondary battery was charged and discharged repeatedly in the same atmosphere until the total number of cycles became 300 cycles, and thereby the discharge capacity was measured. Finally, the cycle retention ratio (%)=(discharge capacity at the 300th cycle/discharge capacity at the second cycle)*100 was calculated. At the time of charge, constant current and constant voltage charge was performed at a current of 0.2 C until the upper voltage of 4.2 V. At the time of discharge, constant current discharge was performed at a current of 0.2 C until the final voltage of 2.5 V. “0.2 C” is a current value at which the theoretical capacity is discharged up in 5 hours.

In examining the storage characteristics, after 2 cycles of charge and discharge were performed in the atmosphere at 23 deg C., the discharge capacity was measured. Subsequently, after the battery was stored in a constant temperature bath at 80 deg C. for 10 days in a state of being charged again, discharge was performed in the atmosphere at 23 deg C., and the discharge capacity was measured. Finally, the storage retention ratio (%)=(discharge capacity after storage/discharge capacity before storage)*100 was calculated. The charge and discharge conditions were similar to those in the case of examining the cycle characteristics.

In examining the load characteristics, after 1 cycle of charge and discharge was performed in the atmosphere at 23 deg C., charge was performed again and the charge capacity was measured. Subsequently, discharge was performed in the same atmosphere to measure the discharge capacity. Finally, the load retention ratio (%)=(discharge capacity at the second cycle/charge capacity at the second cycle)*100 was calculated. The charge and discharge conditions were similar to those in the case of examining the cycle characteristics, except for changing the current at the time of discharge at the second cycle to 3C. “3C” is a current value at which the theoretical value is able to be discharged in ⅓ hour.

TABLE 1
Anode active material: artificial graphite

| | | Electrolyte salt | | | | Cycle | Storage | Load |
|---|---|---|---|---|---|---|---|---|
| | Nonaqueous | | Content | | Content | retention | retention | retention |
| Table 1 | solvent | Type | (mol/kg) | Type | (mol/kg) | ratio (%) | ratio (%) | ratio (%) |
| Example 1-1 | EC + DMC | LiPF₆ | 1 | Formula | 0.001 | 80 | 88 | 89 |
| Example 1-2 | | | | (1-21) | 0.01 | 82 | 87 | 90 |
| Example 1-3 | | | | | 0.02 | 84 | 87 | 92 |
| Example 1-4 | | | | | 0.05 | 84 | 89 | 92 |
| Example 1-5 | | | | | 0.1 | 86 | 89 | 92 |
| Example 1-6 | | | | | 0.2 | 88 | 89 | 92 |
| Example 1-7 | | | | | 0.3 | 87 | 88 | 90 |
| Example 1-8 | | | | | 0.5 | 82 | 82 | 88 |
| Example 1-9 | | | | Formula | 0.05 | 82 | 84 | 88 |
| | | | | (1-22) | | | | |
| Example 1-10 | | | | Formula | 0.05 | 80 | 82 | 90 |
| | | | | (1-23) | | | | |
| Example 1-11 | EC + DMC | LiPF₆ | 1 | Formula | 0.001 | 77 | 83 | 87 |
| Example 1-12 | | | | (2-11) | 0.05 | 80 | 85 | 87 |
| Example 1-13 | | | | | 0.5 | 79 | 83 | 86 |
| Example 1-14 | EC + DMC | LiPF₆ | 1 | Formula | 0.001 | 78 | 84 | 86 |
| Example 1-15 | | | | (3-11) | 0.01 | 80 | 84 | 88 |
| Example 1-16 | | | | | 0.05 | 80 | 84 | 90 |
| Example 1-17 | | | | | 0.1 | 82 | 86 | 90 |
| Example 1-18 | | | | | 0.2 | 82 | 86 | 90 |
| Example 1-19 | | | | | 0.3 | 82 | 86 | 88 |
| Example 1-20 | | | | | 0.5 | 80 | 85 | 87 |
| Example 1-21 | EC + DMC | LiPF₆ | 1 | Formula | 0.001 | 77 | 83 | 87 |
| Example 1-22 | | | | (4-11) | 0.05 | 79 | 84 | 87 |
| Example 1-23 | | | | | 0.5 | 77 | 83 | 86 |
| Example 1-24 | EC + DMC | LiPF₆ | 1 | Formula | 0.001 | 77 | 82 | 87 |
| Example 1-25 | | | | (5-11) | 0.05 | 80 | 82 | 87 |
| Example 1-26 | | | | | 0.5 | 78 | 82 | 86 |

TABLE 2
Anode active material: artificial graphite

| | | Electrolyte salt | | | | Cycle | Storage | Load |
|---|---|---|---|---|---|---|---|---|
| | Nonaqueous | | Content | | Content | retention | retention | retention |
| Table 2 | solvent | Type | (mol/kg) | Type | (mol/kg) | ratio (%) | ratio (%) | ratio (%) |
| Example 1-27 | EC + DMC | LiBF₄ | 1 | Formula | 0.001 | 60 | 77 | 75 |
| Example 1-28 | | | | (1-21) | 0.02 | 64 | 77 | 75 |
| Example 1-29 | | | | | 0.1 | 65 | 79 | 76 |
| Example 1-30 | | | | | 0.2 | 67 | 79 | 75 |
| Example 1-31 | | | | | 0.3 | 67 | 79 | 75 |
| Example 1-32 | | | | | 0.5 | 62 | 73 | 73 |
| Example 1-33 | | | | Formula | 0.1 | 55 | 75 | 74 |
| | | | | (2-11) | | | | |
| Example 1-34 | | | | Formula | 0.1 | 60 | 74 | 74 |
| | | | | (3-11) | | | | |
| Example 1-35 | | | | Formula | 0.1 | 55 | 74 | 73 |
| | | | | (4-11) | | | | |
| Example 1-36 | | | | Formula | 0.1 | 58 | 75 | 73 |
| | | | | (5-11) | | | | |
| Example 1-37 | EC + DMC | LiPF₆ + | 1 + 0.1 | Formula | 0.1 | 88 | 92 | 90 |
| | | LiBF₄ | | (5-11) | | | | |
| Example 1-38 | EC + DMC | LiPF₆ | 1 | — | — | 76 | 82 | 85 |
| Example 1-39 | | LiBF₄ | 1 | — | — | 54 | 72 | 72 |
| Example 1-40 | | — | — | Formula | 1 | 51 | 70 | 66 |
| | | | | (1-21) | | | | |
| Example 1-41 | | | | Formula | | 42 | 46 | 60 |
| | | | | (1-22) | | | | |
| Example 1-42 | | | | Formula | | 42 | 45 | 60 |
| | | | | (1-23) | | | | |
| Example 1-43 | | | | Formula | | 42 | 45 | 58 |
| | | | | (2-11) | | | | |
| Example 1-44 | | | | Formula | | 35 | 48 | 57 |
| | | | | (3-11) | | | | |
| Example 1-45 | | | | Formula | | 32 | 50 | 57 |
| | | | | (4-11) | | | | |
| Example 1-46 | | | | Formula | | 40 | 55 | 58 |
| | | | | (5-11) | | | | |

In the case where combination of the nitrogen-containing organic anion (lithium salt shown in Formula (1-21) or the like) and the fluorine-containing inorganic anion (LiPF₆ or LiBF₄) was used, high cycle retention ratio, high storage retention ratio, and high load retention ratio were obtained.

More specifically, in the case where only the nitrogen-containing organic anion was used, the cycle retention ratio, the storage retention ration, and the load retention ratio were significantly lowered more than in the case of using only the fluorine-containing inorganic anion. Meanwhile, in the case where combination of the nitrogen-containing organic anion and the fluorine-containing inorganic anion was used, the cycle retention ratio and the load retention ratio were higher than those in the case of using only the fluorine-containing inorganic anion, and the storage retention ratio was larger than or equal to that in the case of using only the fluorine-containing inorganic anion.

In particular, in the case where combination of the nitrogen-containing organic anion and the fluorine-containing inorganic anion was used, if the nitrogen-containing organic anion was contained at the ratio from 0.001 mol to 0.5 mol both inclusive per 1 mol of the fluorine-containing inorganic anion, favorable result was obtained.

### Examples 2-1 to 2-14

Secondary batteries were fabricated by a procedure similar to that of Examples 1-1 to 1-46 except that the composition of the nonaqueous solvent was changed as illustrated in Table 3, and the respective characteristics were examined. In this case, the following nonaqueous solvents were used. That is, diethyl carbonate (DEC), ethylmethyl carbonate (EMC), or propylene carbonate (PC) was used. Further, vinylene carbonate (VC), bis(fluoromethyl)carbonate (DFDMC), 4-fluoro-1,3-dioxolane-2-one (FEC), or trans-4,5-difluoro-1,3-dioxolane-2-one (DFEC) was used. Further, propene sultone (PRS), glutaric anhydride (GLAH), or sulfopropionic anhydride (SPAH) was used. The mixture ratio of the nonaqueous solvent was EC:DEC=50:50, EC:EMC=50:50, PC:DMC=50:50, and EC:PC: DMC=10:20:70 at a weight ratio. The content of VC or the like in the nonaqueous solvent was 2 wt %.

TABLE 3
Anode active material: artificial graphite

| | | | Electrolyte salt | | | | Cycle | Storage |
|---|---|---|---|---|---|---|---|---|
| | | | | Content | | Content | retention | retention |
| Table 3 | Nonaqueous solvent | | Type | (mol/kg) | Type | (mol/kg) | ratio (%) | ratio (%) |
| Example 2-1 | EC + DEC | | LiPF₆ | 1 | Formula | 0.05 | 84 | 92 |
| Example 2-2 | EC + EMC | | | | (1-21) | | 84 | 92 |
| Example 2-3 | PC + DMC | | | | | | 82 | 90 |
| Example 2-4 | EC + PC + DMC | | | | | | 86 | 90 |
| Example 2-5 | EC + DMC | VC | LiPF₆ | 1 | Formula | 0.05 | 90 | 94 |
| Example 2-6 | | DFDMC | | | (5-11) | | 90 | 92 |
| Example 2-7 | | FEC | | | | | 93 | 93 |
| Example 2-8 | | DFEC | | | | | 92 | 93 |
| Example 2-9 | | PRS | | | | | 90 | 95 |
| Example 2-10 | | GLAH | | | | | 92 | 94 |
| Example 2-11 | | SPAH | | | | | 91 | 95 |
| Example 2-12 | EC + DMC | VC | LiPF₆ | 1 | — | — | 82 | 87 |
| Example 2-13 | | FEC | | | | | 82 | 85 |
| Example 2-14 | | DFEC | | | | | 82 | 87 |

In the case where the composition of the nonaqueous solvent was changed, high cycle retention ratio and high storage retention ratio were obtained as in Table 1 and Table 2.

### Examples 3-1 and 3-2

Secondary batteries were fabricated by a procedure similar to that of Examples 1-1 to 1-46 except that the composition of the electrolyte salt was changed as illustrated in Table 4, and the respective characteristics were examined. In this case, as an electrolyte salt, (4,4,4-trifluorobutyrate oxalato) lithium borate (LiTFOB) shown in Formula (12-8) or bis(trifluoromethanesulfonyl)imide lithium (LiN(CF₃SO₂)₂: LiTFSI) was used.

TABLE 4
Anode active material: artificial graphite

| | | Electrolyte salt | | | | | | Cycle | Storage |
|---|---|---|---|---|---|---|---|---|---|
| | Nonaqueous | | Content | | Content | | Content | retention | retention |
| Table 4 | solvent | Type | (mol/kg) | Type | (mol/kg) | Type | (mol/kg) | ratio (%) | ratio (%) |
| Example 3-1 | EC + DMC | LiPF₆ | 1 | Formula | 0.05 | LiTFOB | 0.1 | 88 | 92 |
| Example 3-2 | | | | (5-11) | | LiTFSI | | 89 | 92 |

In the case where the composition of the electrolyte salt was changed, high cycle retention ratio and high storage retention ratio were obtained as in Table 1 and Table 2.

### Examples 4-1 to 4-46

Secondary batteries were fabricated by a procedure similar to that of Examples 1-1 to 1-46 except that silicon was used as an anode active material, and the composition of the electrolytic solution was changed by using DEC instead of DMC as illustrated in Table 5 and Table 6, and the respective characteristics were examined. In forming the anode 22, silicon was deposited on the surface of the anode current collector 22A by evaporation method (electron beam evaporation method) to form the anode active material layer 22B. In this case, 10 times of deposition steps were repeated to obtain the total thickness of the anode active material layer 22B of 6 μm.

TABLE 5
Anode active material: silicon

| | | Electrolyte salt | | | | Cycle | Storage | Load |
|---|---|---|---|---|---|---|---|---|
| | Nonaqueous | | Content | | Content | retention | retention | retention |
| Table 5 | solvent | Type | (mol/kg) | Type | (mol/kg) | ratio (%) | ratio (%) | ratio (%) |
| Example 4-1 | EC + DEC | LiPF₆ | 1 | Formula | 0.001 | 45 | 88 | 88 |
| Example 4-2 | | | | (1-21) | 0.01 | 52 | 87 | 90 |
| Example 4-3 | | | | | 0.02 | 54 | 87 | 90 |
| Example 4-4 | | | | | 0.05 | 56 | 92 | 90 |
| Example 4-5 | | | | | 0.1 | 56 | 89 | 90 |
| Example 4-6 | | | | | 0.2 | 58 | 89 | 92 |
| Example 4-7 | | | | | 0.3 | 56 | 88 | 91 |
| Example 4-8 | | | | | 0.5 | 52 | 82 | 90 |
| Example 4-9 | | | | Formula | 0.05 | 52 | 84 | 88 |
| | | | | (1-22) | | | | |
| Example 4-10 | | | | Formula | 0.05 | 50 | 82 | 88 |
| | | | | (1-23) | | | | |
| Example 4-11 | EC + DEC | LiPF₆ | 1 | Formula | 0.001 | 42 | 85 | 88 |
| Example 4-12 | | | | (2-11) | 0.05 | 45 | 86 | 89 |
| Example 4-13 | | | | | 0.5 | 42 | 85 | 88 |
| Example 4-14 | EC + DEC | LiPF₆ | 1 | Formula | 0.001 | 42 | 84 | 88 |
| Example 4-15 | | | | (3-11) | 0.01 | 45 | 84 | 90 |
| Example 4-16 | | | | | 0.05 | 50 | 84 | 89 |
| Example 4-17 | | | | | 0.1 | 50 | 85 | 89 |
| Example 4-18 | | | | | 0.2 | 50 | 86 | 92 |
| Example 4-19 | | | | | 0.3 | 48 | 86 | 91 |
| Example 4-20 | | | | | 0.5 | 46 | 84 | 90 |
| Example 4-21 | EC + DEC | LiPF₆ | 1 | Formula | 0.001 | 42 | 80 | 88 |
| Example 4-22 | | | | (4-11) | 0.05 | 49 | 80 | 88 |
| Example 4-23 | | | | | 0.5 | 44 | 80 | 88 |
| Example 4-24 | EC + DEC | LiPF₆ | 1 | Formula | 0.001 | 45 | 80 | 88 |
| Example 4-25 | | | | (5-11) | 0.05 | 50 | 82 | 88 |
| Example 4-26 | | | | | 0.5 | 46 | 80 | 88 |

TABLE 6
Anode active material: silicon

| | | Electrolyte salt | | | | Cycle | Storage | Load |
|---|---|---|---|---|---|---|---|---|
| | Nonaqueous | | Content | | Content | retention | retention | retention |
| Table 6 | solvent | Type | (mol/kg) | Type | (mol/kg) | ratio (%) | ratio (%) | ratio (%) |
| Example 4-27 | EC + DEC | LiBF₄ | 1 | Formula | 0.001 | 41 | 74 | 78 |
| Example 4-28 | | | | (1-21) | 0.01 | 44 | 74 | 80 |
| Example 4-29 | | | | | 0.1 | 47 | 75 | 82 |
| Example 4-30 | | | | | 0.2 | 48 | 76 | 82 |
| Example 4-31 | | | | | 0.3 | 48 | 76 | 81 |
| Example 4-32 | | | | | 0.5 | 47 | 75 | 80 |
| Example 4-33 | | | | Formula | 0.1 | 40 | 74 | 77 |
| | | | | (2-11) | | | | |
| Example 4-34 | | | | Formula | 0.1 | 42 | 74 | 79 |
| | | | | (3-11) | | | | |
| Example 4-35 | | | | Formula | 0.1 | 38 | 74 | 77 |
| | | | | (4-11) | | | | |
| Example 4-36 | | | | Formula | 0.1 | 40 | 74 | 77 |
| | | | | (5-11) | | | | |
| Example 4-37 | EC + DEC | LiPF₆ + | 1 + 0.1 | Formula | 0.2 | 64 | 92 | 90 |
| | | LiBF₄ | | (5-11) | | | | |
| Example 4-38 | EC + DEC | LiPF₆ | 1 | — | — | 40 | 80 | 87 |
| Example 4-39 | | LiBF₄ | 1 | — | — | 30 | 73 | 73 |
| Example 4-40 | | — | — | Formula | 1 | 25 | 55 | 56 |
| | | | | (1-21) | | | | |
| Example 4-41 | | | | Formula | | 20 | 50 | 50 |
| | | | | (1-22) | | | | |
| Example 4-42 | | | | Formula | | 20 | 42 | 52 |
| | | | | (1-23) | | | | |
| Example 4-43 | | | | Formula | | 20 | 40 | 50 |
| | | | | (2-11) | | | | |
| Example 4-44 | | | | Formula | | 23 | 38 | 48 |
| | | | | (3-11) | | | | |
| Example 4-45 | | | | Formula | | 18 | 44 | 48 |
| | | | | (4-11) | | | | |
| Example 4-46 | | | | Formula | | 22 | 42 | 49 |
| | | | | (5-11) | | | | |

In the case where silicon was used as an anode active material, results equal to those in the case of using the carbon material (Table 1 and Table 2) were obtained. That is, high cycle retention ratio, high storage retention ratio, and high load retention ratio were obtained.

### Examples 5-1 to 5-14

Secondary batteries were fabricated by a procedure similar to that of Examples 4-1 to 4-46 except that the composition of the nonaqueous solvent was changed as illustrated in Table 7, and the respective characteristics were examined. In this case, the mixture ratio of the nonaqueous solvent was EC:DMC=50:50, EC:EMC=50:50, PC:DEC=50:50, and EC:PC:DEC=10:20:70 at a weigh ratio. The content of VC or the like in the nonaqueous solvent was 5 wt %.

TABLE 7
Anode active material: silicon

| | | | Electrolyte salt | | | | Cycle | Storage |
|---|---|---|---|---|---|---|---|---|
| | | | | Content | | Content | retention | retention |
| Table 7 | Nonaqueous solvent | | Type | (mol/kg) | Type | (mol/kg) | ratio (%) | ratio (%) |
| Example 5-1 | EC + DMC | | LiPF₆ | 1 | Formula | 0.05 | 55 | 89 |
| Example 5-2 | EC + EMC | | | | (1-21) | | 55 | 92 |
| Example 5-3 | PC + DEC | | | | | | 52 | 90 |
| Example 5-4 | EC + PC + DEC | | | | | | 54 | 90 |
| Example 5-5 | EC + DEC | VC | LiPF₆ | 1 | Formula | 0.05 | 75 | 94 |
| Example 5-6 | | DFDMC | | | (5-11) | | 70 | 92 |
| Example 5-7 | | FEC | | | | | 73 | 93 |
| Example 5-8 | | DFEC | | | | | 83 | 93 |
| Example 5-9 | | PRS | | | | | 83 | 95 |
| Example 5-10 | | GLAH | | | | | 82 | 94 |
| Example 5-11 | | SPAH | | | | | 58 | 95 |
| Example 5-12 | EC + DEC | VC | LiPF₆ | 1 | — | — | 70 | 84 |
| Example 5-13 | | FEC | | | | | 66 | 86 |
| Example 5-14 | | DFEC | | | | | 80 | 88 |

In the case where silicon was used as an anode active material, results equal to those in the case of using the carbon material (Table 3) were obtained. That is, high cycle retention ratio and high storage retention ratio were obtained.

### Examples 6-1 and 6-2

Secondary batteries were fabricated by a procedure similar to that of Examples 4-1 to 4-46 except that the composition of the electrolyte salt was changed as illustrated in Table 8, and the respective characteristics were examined.

TABLE 8
Anode active material: silicon

| | | Electrolyte salt | | | | | | Cycle | Storage |
|---|---|---|---|---|---|---|---|---|---|
| | Nonaqueous | | Content | | Content | | Content | retention | retention |
| Table 8 | solvent | Type | (mol/kg) | Type | (mol/kg) | Type | (mol/kg) | ratio (%) | ratio (%) |
| Example 6-1 | EC + DEC | LiPF₆ | 1 | Formula | 0.05 | LiTFOB | 0.1 | 68 | 93 |
| Example 6-2 | | | | (5-11) | | LiTFSI | | 65 | 92 |

In the case where silicon was used as an anode active material, results equal to those in the case of using the carbon material (Table 4) were obtained. That is, high cycle retention ratio and high storage retention ratio were obtained.

From the results of Table 1 to Table 8, the following was derived. In this application, the electrolytic solution contains the nitrogen-containing organic anion and the fluorine-containing inorganic anion together with lithium ions. Thereby, superior cycle characteristics, superior storage characteristics, and superior load characteristics are able to be obtained without depending on the type of the anode active material, the composition of the nonaqueous solvent, the composition of the electrolyte salt and the like.

In this case, the increase ratios of the cycle retention ratio in the case that the metal material (silicon) was used as an anode active material were larger than those in the case that the carbon material (artificial graphite) was used as an anode active material. Accordingly, higher effect is able to be obtained in the case that the metal material (silicon) is used as an anode active material than in the case that the carbon material (artificial graphite) is used as an anode active material. The result may be obtained for the following reason. That is, in the case where the metal material advantageous to realizing a high capacity was used as an anode active material, the electrolytic solution was more easily decomposed than in a case that the carbon material was used. Accordingly, decomposition inhibition effect of the electrolytic solution was significantly demonstrated.

The application has been described with reference to the embodiment and the examples. However, the application is not limited to the aspects described in the embodiment and the aspects described in the examples, and various modifications may be made. For example, use application of the electrolytic solution for a lithium secondary battery of the application is not necessarily limited to the lithium secondary battery, but may be other device such as a capacitor.

Further, in the embodiment and the examples, the description has been given of the lithium ion secondary battery or the lithium metal secondary battery as a lithium secondary battery type. However, the lithium secondary battery of the application is not limited thereto. The application is similarly applicable to a secondary battery in which the anode capacity includes the capacity by inserting and extracting lithium ions and the capacity associated with precipitation and dissolution of lithium metal, and the anode capacity is expressed by the sum of these capacities. In this case, an anode material capable of inserting and extracting lithium ions is used as an anode active material, and the chargeable capacity of the anode material is set to a smaller value than the discharge capacity of the cathode.

Further, in the embodiment and the examples, the description has been given with the specific examples of the case in which the battery structure is the cylindrical type or the laminated film type, and with the specific example in which the battery element has the spirally wound structure. However, applicable structures are not limited thereto. The lithium secondary battery of the application is similarly applicable to a battery having other battery structure such as a square type battery, a coin type battery, and a button type battery or a battery in which the battery element has other structure such as a laminated structure.

Further, in the embodiment and the examples, for the contents of lithium ions, the nitrogen-containing organic anion, and the fluorine-containing inorganic anion, and the ratios of both anions, the description has been given of the appropriate ranges derived from the results of the examples. However, the description does not totally deny a possibility that the contents and the ratios are out of the foregoing ranges. That is, the foregoing appropriate ranges are the ranges particularly preferable for obtaining the effects of the application. Therefore, as long as effect of the application is obtained, the content and the ratios may be out of the foregoing ranges in some degrees.

It should be understood that various changes and modifications to the presently preferred embodiments described herein will be apparent to those skilled in the art. Such changes and modifications can be made without departing from the spirit and scope and without diminishing its intended advantages. It is therefore intended that such changes and modifications be covered by the appended claims.

The application is claimed as follows:

1. A lithium secondary battery comprising:
a cathode;
an anode; and
an electrolytic solution,
wherein the electrolytic solution contains a nonaqueous solvent, a lithium ion (Li+), at least one of organic anions expressed by Formula 1 to Formula 5, and at least one of inorganic anions having fluorine and an element of Group 13 to Group 15 in the long period periodic table as an element. 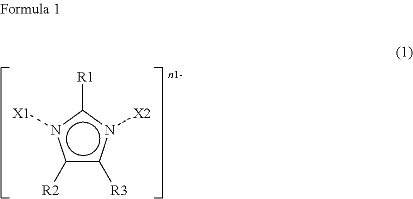
where R1 to R3 are a hydrogen group, a sulfonate ion group (—SO₃—), or an organic group; X1 and X2 are a Lewis acidic ligand; n1 is an integer number greater than 1 or equal to 1; and R2 and R3 may be bonded to each other to form a ring structure. 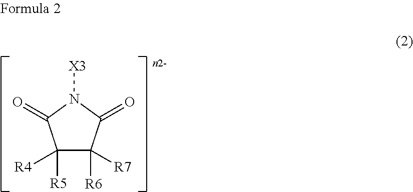
where R4 to R7 are a hydrogen group, a sulfonate ion group, or an organic group; X3 is a Lewis acidic ligand; n2 is an integer number greater than 1 or equal to 1; and R4 to R7 may be bonded to each other to form a ring structure. 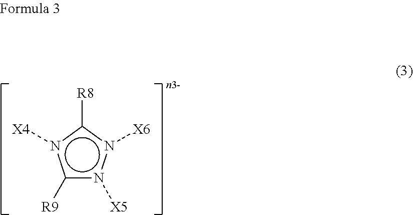
where R8 and R9 are a hydrogen group, a sulfonate ion group, or an organic group; X4 to X6 are a Lewis acidic ligand; and n3 is an integer number greater than 1 or equal to 1. 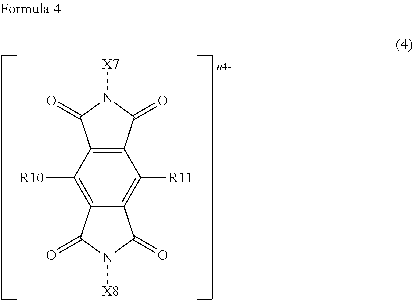
where R10 and R11 are a hydrogen group, a sulfonate ion group, or an organic group; X7 and X8 are a Lewis acidic ligand; and n4 is an integer number greater than 2 or equal to 2. 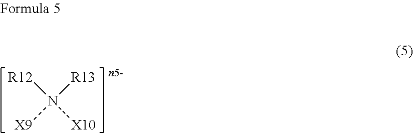
where R12 and R13 are a sulfonate ion group or an organic group; X9 and X10 are a Lewis acidic ligand; and n5 is an integer number greater than or equal to 1.

2. The lithium secondary battery according to claim 1, wherein the Lewis acidic ligand is BF₃, B(OCH₃)₃, B(C₆H₅)₃, B(C₆F₅)₃, or B(OCH(CF₃)₂)₃, and the inorganic anion is hexafluorophosphate ion (PF₆⁻) or tetrafluoroborate ion (BF₄⁻).

3. The lithium secondary battery according to claim 1, wherein the organic group is a carbon hydride group with carbon number from 1 to 10 both inclusive or a halogenated carbon hydride group with carbon number from 1 to 10 both inclusive.

4. The lithium secondary battery according to claim 1, wherein the organic anion shown in the Formula 1 is at least one of anions expressed by Formula (1-1) to Formula (1-17),
the organic anion shown in the Formula 2 is at least one of anions expressed by Formula (2-1) and Formula (2-2),
the organic anion shown in the Formula 3 is at least one of anions expressed by Formula (3-1) and Formula (3-2),
the organic anion shown in the Formula 4 is at least one of anions expressed by Formula (4-1) and Formula (4-2), and
the organic anion shown in the Formula 5 is at least one of anions expressed by Formula (5-1) to Formula (5-6).

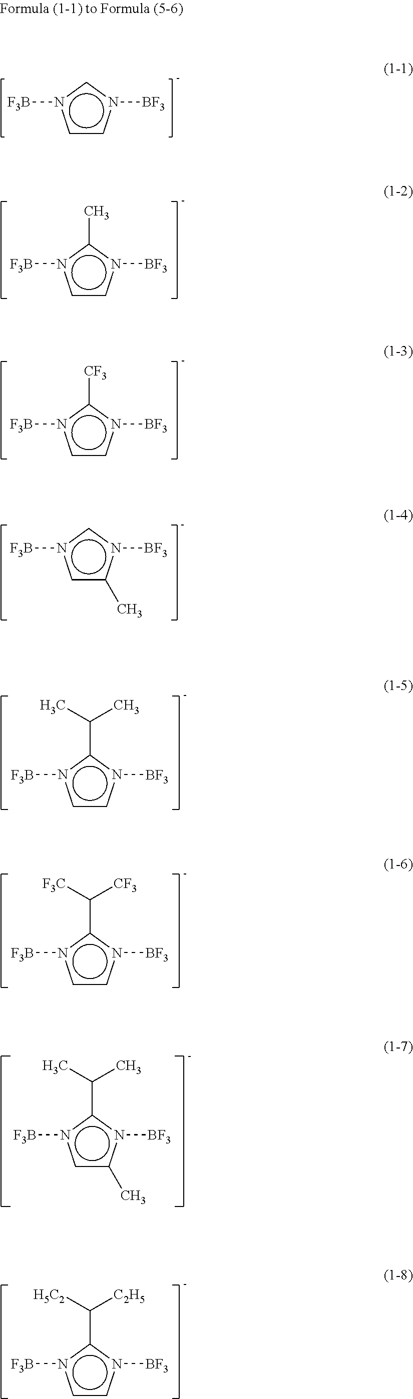

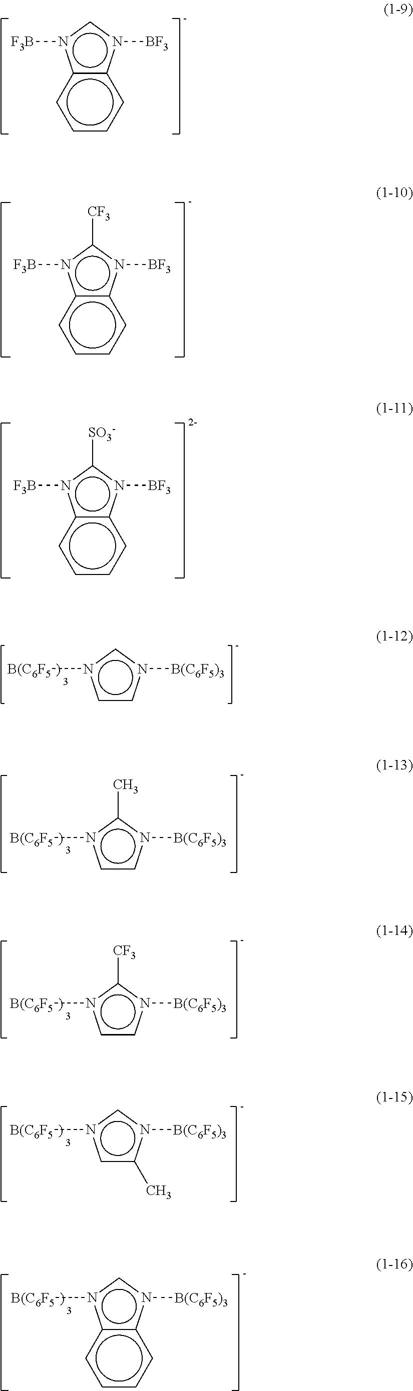

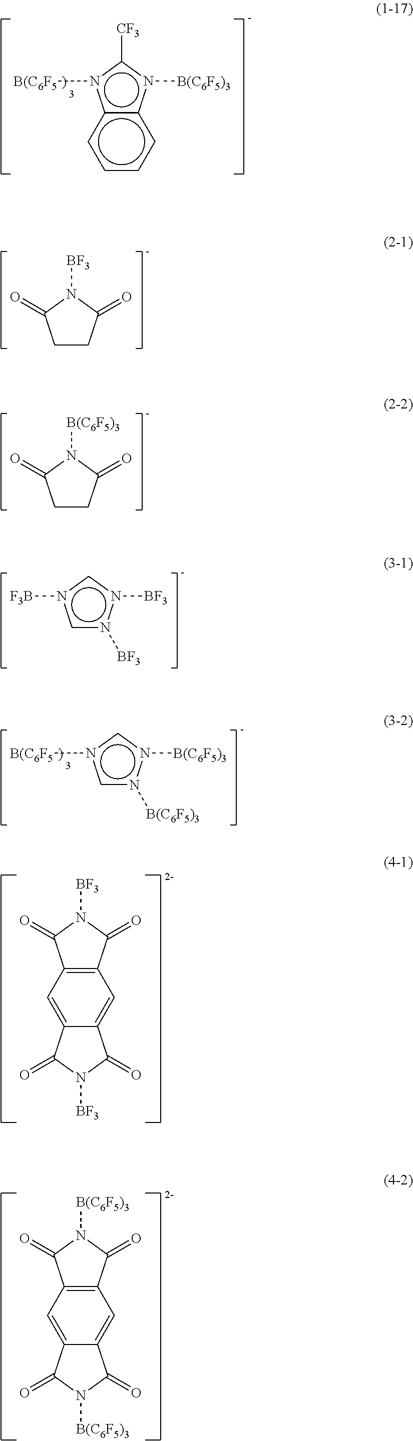

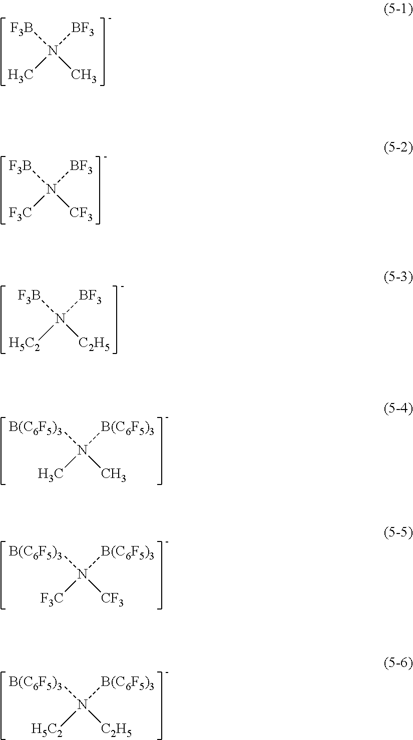

5. The lithium secondary battery according to claim 1, wherein the organic anion is contained in the electrolytic solution at a ratio from 0.001 mol to 0.5 mol both inclusive per 1 mol of the inorganic anion.

6. The lithium secondary battery according to claim 1, wherein the anode contains, as an anode active material, a carbon material, lithium metal (Li), or a material that is able to insert and extract the lithium ion and that has at least one of a metal element and a metalloid element as an element.

7. The lithium secondary battery according to claim 1, wherein the anode contains, as an anode active material, a material having at least one of silicon (Si) and tin (Sn) as an element.

8. An electrolytic solution for a lithium secondary battery containing
a nonaqueous solvent,
a lithium ion,
at least one of organic anions expressed by Formula 1 to Formula 5, and
at least one of inorganic anions having fluorine and an element of Group 13 to Group 15 in the long period periodic table as an element. 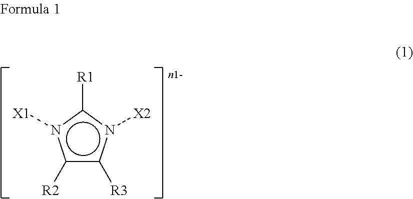
where R1 to R3 are a hydrogen group, a sulfonate ion group, or an organic group; X1 and X2 are a Lewis acidic ligand; n1 is an integer number greater than 1 or equal to 1; and R2 and R3 may be bonded to each other to form a ring structure. 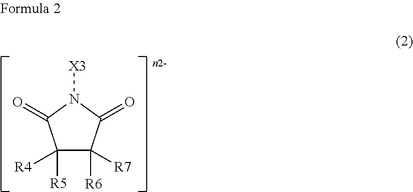
where R4 to R7 are a hydrogen group, a sulfonate ion group, or an organic group; X3 is a Lewis acidic ligand; n2 is an integer number greater than 1 or equal to 1; and R4 to R7 may be bonded to each other to form a ring structure. 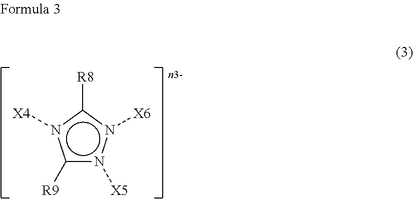
where R8 and R9 are a hydrogen group, a sulfonate ion group, or an organic group; X4 to X6 are a Lewis acidic ligand; and n3 is an integer number greater than 1 or equal to 1. 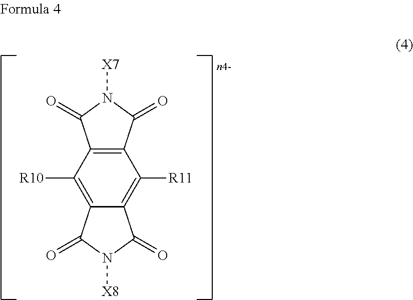
where R10 and R11 are a hydrogen group, a sulfonate ion group, or an organic group; X7 and X8 are a Lewis acidic ligand; and n4 is an integer number greater than 2 or equal to 2. 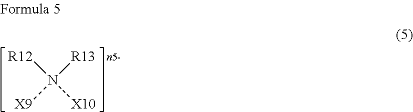
where R12 and R13 are a sulfonate ion group or an organic group; X9 and X10 are a Lewis acidic ligand; and n5 is an integer number greater than 1 or equal to 1.

9. An electric power tool mounting a lithium secondary battery including a cathode, an anode and an electrolytic solution, and moving with the use of the lithium secondary battery as a power source,
wherein the electrolytic solution contains a nonaqueous solvent, a lithium ion, at least one of organic anions expressed by Formula 1 to Formula 5, and at least one of inorganic anions having fluorine and an element of Group 13 to Group 15 in the long period periodic table as an element. 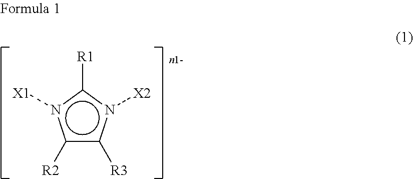
where R1 to R3 are a hydrogen group, a sulfonate ion group, or an organic group; X1 and X2 are a Lewis acidic ligand; n1 is an integer number greater than 1 or equal to 1; and R2 and R3 may be bonded to each other to form a ring structure. 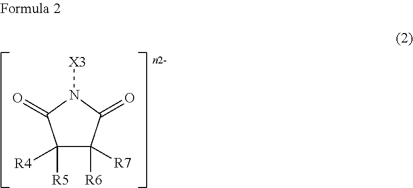
where R4 to R7 are a hydrogen group, a sulfonate ion group, or an organic group; X3 is a Lewis acidic ligand; n2 is an integer number greater than 1 or equal to 1; and R4 to R7 may be bonded to each other to form a ring structure. 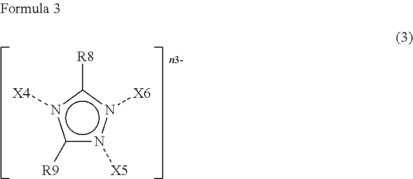
where R8 and R9 are a hydrogen group, a sulfonate ion group, or an organic group; X4 to X6 are a Lewis acidic ligand; and n3 is an integer number greater than 1 or equal to 1. 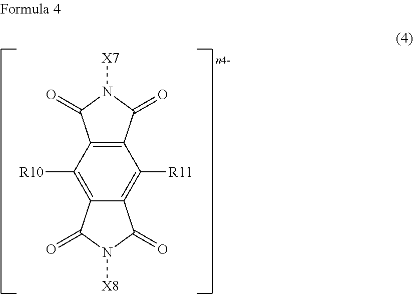
where R10 and R11 are a hydrogen group, a sulfonate ion group, or an organic group; X7 and X8 are a Lewis acidic ligand; and n4 is an integer number greater than 2 or equal to 2. 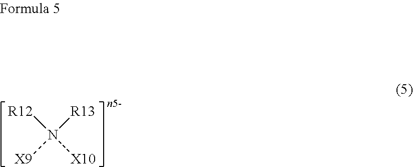
where R12 and R13 are a sulfonate ion group or an organic group; X9 and X10 are a Lewis acidic ligand; and n5 is an integer number greater than 1 or equal to 1.

10. An electrical vehicle mounting a lithium secondary battery including a cathode, an anode and an electrolytic solution and working with the use of the lithium secondary battery as a power source,
wherein the electrolytic solution contains a nonaqueous solvent, a lithium ion, at least one of organic anions expressed by Formula 1 to Formula 5, and at least one of inorganic anions having fluorine and an element of Group 13 to Group 15 in the long period periodic table as an element. 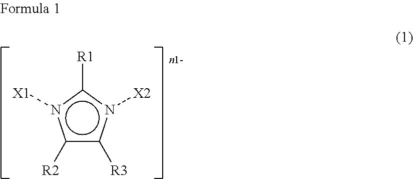
where R1 to R3 are a hydrogen group, a sulfonate ion group, or an organic group; X1 and X2 are a Lewis acidic ligand; n1 is an integer number greater than or equal to 1; and R2 and R3 may be bonded to each other to form a ring structure. 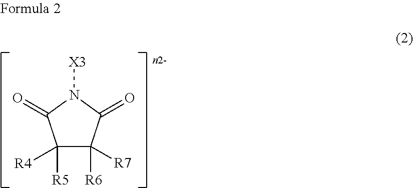
where R4 to R7 are a hydrogen group, a sulfonate ion group, or an organic group; X3 is a Lewis acidic ligand; n2 is an integer number greater than 1 or equal to 1; and R4 to R7 may be bonded to each other to form a ring structure. 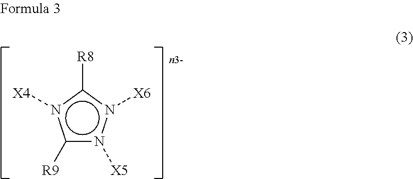
where R8 and R9 are a hydrogen group, a sulfonate ion group, or an organic group; X4 to X6 are a Lewis acidic ligand; and n3 is an integer number greater than 1 or equal to 1. 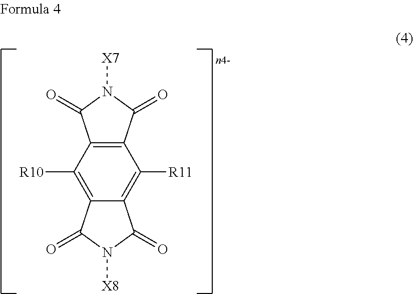
where R10 and R11 are a hydrogen group, a sulfonate ion group, or an organic group; X7 and X8 are a Lewis acidic ligand; and n4 is an integer number greater than 2 or equal to 2. 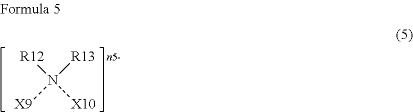
where R12 and R13 are a sulfonate ion group or an organic group; X9 and X10 are a Lewis acidic ligand; and n5 is an integer number greater than 1 or equal to 1.

11. An electric power storage system mounting a lithium secondary battery including a cathode, an anode and an electrolytic solution, and using the lithium secondary battery as an electric power storage source,
wherein the electrolytic solution contains a nonaqueous solvent, a lithium ion, at least one of organic anions expressed by Formula 1 to Formula 5, and at least one of inorganic anions having fluorine and an element of Group 13 to Group 15 in the long period periodic table as an element. 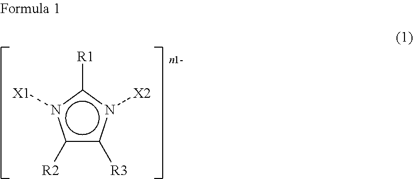
where R1 to R3 are a hydrogen group, a sulfonate ion group, or an organic group; X1 and X2 are a Lewis acidic ligand; n1 is an integer number greater than 1 or equal to 1; and R2 and R3 may be bonded to each other to form a ring structure. 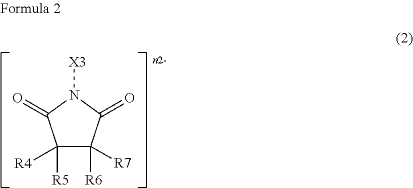
where R4 to R7 are a hydrogen group, a sulfonate ion group, or an organic group; X3 is a Lewis acidic ligand; n2 is an integer number greater than 1 or equal to 1; and R4 to R7 may be bonded to each other to form a ring structure. 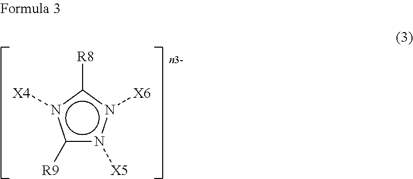
where R8 and R9 are a hydrogen group, a sulfonate ion group, or an organic group; X4 to X6 are a Lewis acidic ligand; and n3 is an integer number greater than 1 or equal to 1. 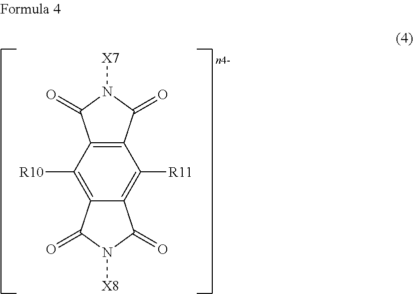
where R10 and R11 are a hydrogen group, a sulfonate ion group, or an organic group; X7 and X8 are a Lewis acidic ligand; and n4 is an integer number greater than 2 or equal to 2. 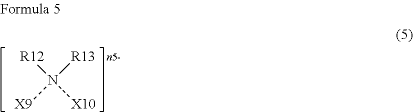
where R12 and R13 are a sulfonate ion group or an organic group; X9 and X10 are a Lewis acidic ligand; and n5 is an integer number greater than 1 or equal to 1.
